(19) United States
(12) Patent Application Publication
(10) Pub. No.: US 2026/0337067 A1
(43) Pub. Date: Oct. 29, 2026

(54) WATER TREATMENT DEVICE AND DISHWASHER HAVING THE SAME

(71) Applicant: SAMSUNG ELECTRONICS CO., LTD., Suwon-si (KR)

(72) Inventors: Gimun GWAK, Suwon-si (KR); Johannes BÜSING, Suwon-si (KR); Wonyoung SEO, Suwon-si (KR); Jungha PARK, Suwon-si (KR)

(73) Assignee: SAMSUNG ELECTRONICS CO., LTD., Suwon-si (KR)

(21) Appl. No.: 19/648,811

(22) Filed: Apr. 15, 2026

Related U.S. Application Data
(63) Continuation of application No. PCT/KR2026/004221, filed on Mar. 16, 2026.

(30) Foreign Application Priority Data
Apr. 29, 2025 (KR) 10-2025-0056760
Jul. 4, 2025 (KR) 10-2025-0090369

(51) Int. Cl. C02F 1/469; A47L 15/42; C02F 103/02

(52) U.S. Cl. CPC C02F 1/4691; A47L 15/4229; C02F 2103/02; C02F 2307/12

(57) ABSTRACT

A water treatment device includes a case with an inlet port and an outlet port, and a deionization electrode accommodated in the case and configured to adsorb ionic substances from water entering the case through the inlet port. The case includes a first case, a second case couplable to the first case and configured to form an accommodating space for the deionization electrode between the first case and the second case while coupled to the first case, and a coupling case configured to couple the second case to the first case, the coupling case including a support configured to support the second case while the second case moves toward the first case to couple to the first case.

### CROSS-REFERENCE TO RELATED APPLICATION

This application is a continuation application, under 35 U.S.C. § 111(a), of International application No. PCT/KR2026/004221, filed Mar. 16, 2026, which claims priority under 35 U.S.C. § 119 to Korean Patent Application No. 10-2025-0056760, filed Apr. 29, 2025, and Korean Patent Application No. 10-2025-0090369, filed Jul. 4, 2025, in the Ministry of Intellectual Property, the disclosures of which are incorporated herein by reference in their entirety.

### TECHNICAL FIELD

The disclosure relates to a water treatment device and a dishwasher including the same.

### BACKGROUND ART

A dishwasher is a device that uses a high-pressure spray of washing water to wash and dry dishes stored therein. A dishwasher operates such that washing water is sprayed at high pressure inside a washing chamber, in which the dishes are stored, and the sprayed washing water comes into contact with the dishes to wash off foreign matter, such as food residues, from the surface of the dishes.

The dishwasher includes a tub for forming a washing chamber and a sump for storing water, mounted on the bottom of the tub. Water is moved to a spray nozzle by pumping action of a washing pump mounted inside the sump. The water moved to the spray nozzle is sprayed at high pressure through jets formed in the spray nozzle. As the water sprayed at high pressure strikes the surface of dishes, dirt such as food residues on the dishes falls to the bottom of the tub.

The dishwasher may include a water treatment device capable of converting raw water supplied from a water source into soft water. For example, the water treatment device may include a capacitive deionization (CDI) device. The water treatment device may generate soft water by adsorbing ionic substances contained in the raw water.

### DISCLOSURE

### Technical Problem

An embodiment of the present disclosure provides an improved water treatment device capable of efficiently softening raw water, and a dishwasher including the same.

An embodiment of the present disclosure provides an improved water treatment device capable of controlling the degree to which a deionization electrode is compressed, and a dishwasher including the same.

An embodiment of the present disclosure provides an improved water treatment device capable of reliably connecting a terminal to a deionization electrode even when tolerances between components occur, and a dishwasher including the same.

An embodiment of the present disclosure provides an improved water treatment device capable of firmly assembling a case, and a dishwasher including the same.

An embodiment of the present disclosure provides an improved water treatment device capable of simplifying the process of assembling and/or disassembling a case and reducing manufacturing costs, and a dishwasher including the same.

An embodiment of the present disclosure provides an improved water treatment device capable of reducing and/or preventing damage to a deionization electrode due to friction with a terminal, and a dishwasher including the same.

An embodiment of the present disclosure provides capable of reducing and/or preventing water leakage from a case, and a dishwasher including the same.

Technical tasks to be achieved in this document are not limited to the technical tasks mentioned above, and other technical tasks not mentioned will be clearly understood by those skilled in the art from the description below.

### Technical Solution

A water treatment device according to an embodiment of the present disclosure may include a case with an inlet port and an outlet port and a deionization electrode accommodated in the case and configured to adsorb ionic substances from water entering the case through the inlet port. The case may include a first case, a second case configured to be coupled to the first case such that an accommodating space in which the deionization electrode is arrangeable is formed between the first case and the second case while the second case and the first case coupled to each other, and a coupling case configured to couple the second case to the first case, the coupling case including a support configured to support the second case while the second case moves toward the first case to couple to the first case.

A dishwasher according to an embodiment of the present disclosure may include a tub, a spraying device configured to spray washing water into an interior of the tub, a sump configured to receive washing water to be supplied to the spraying device, and a water treatment device configured to treat washing water to be supplied to the sump. The water treatment device may include a deionization electrode, a terminal in contact with the deionization electrode and electrically connected to an external power source, a first case, a second case couplable to the first case such that an accommodating space in which the deionization electrode is arrangeable is formed between the first case and the second case while the first case is coupled to the second case, and a coupling case configured to couple the first case with the second case. The first case and the coupling case each may include a thread configured to engage with each other for coupling.

A water treatment device according to an embodiment of the present disclosure may include a deionization electrode, a terminal in contact with the deionization electrode and electrically connected to an external power source, a first case, a second case configured to be coupled to the first case such that an accommodating space in which the deionization electrode is arrangeable is formed between the first case and the second case while the first case is coupled to the second case, and a coupling case configured to couple the first case and the second case. The coupling case may include a hook configured to be coupled to the second case. The hook may be configured to press the second case toward the first case when coupled to the second case.

### DESCRIPTION OF DRAWINGS

FIG. 1 is a perspective view of a dishwasher according to an embodiment of the present disclosure.

FIG. 2 is a cross-sectional view of the dishwasher according to an embodiment of the present disclosure.

FIG. 3 is a perspective view illustrating various configurations disposed inside a main body of the dishwasher according to an embodiment of the present disclosure.

FIG. 4 is a perspective view illustrating a tub, and a sump and a water treatment device mounted on the tub of the dishwasher according to an embodiment of the present disclosure.

FIG. 5 is a view illustrating a connection relationship and a flow of washing water among the sump, a case break, and the water treatment device of the dishwasher according to an embodiment of the present disclosure.

FIG. 6 is a perspective view illustrating the case break and the water treatment device of the dishwasher according to an embodiment of the present disclosure.

FIG. 7 is a perspective view illustrating the water treatment device of the dishwasher according to an embodiment of the present disclosure.

FIG. 8 is an exploded perspective view illustrating the water treatment device of the dishwasher according to an embodiment of the present disclosure.

FIG. 9 is a cross-sectional perspective view illustrating the water treatment device of the dishwasher according to an embodiment of the present disclosure.

FIG. 10 is a schematic view illustrating a process of softening water by the water treatment device of the dishwasher according to an embodiment of the present disclosure.

FIG. 11 is a schematic view illustrating a process of removing scale from the water treatment device of the dishwasher according to an embodiment of the present disclosure.

FIG. 12 is a view illustrating various configurations, such as a deionization electrode and a plurality of terminals, included in the water treatment device of the dishwasher according to an embodiment of the present disclosure.

FIG. 13 is an exploded perspective view illustrating some configurations of the water treatment device of the dishwasher according to an embodiment of the present disclosure.

FIG. 14 is a cross-sectional view of the water treatment device of the dishwasher according to an embodiment of the present disclosure.

FIG. 15 is an enlarged cross-sectional view illustrating a part of the water treatment device of the dishwasher according to an embodiment of the present disclosure.

FIG. 16 is an enlarged cross-sectional view illustrating a part of a first case, a second case, and a coupling case included in the water treatment device of the dishwasher according to an embodiment of the present disclosure.

FIG. 17 is an enlarged cross-sectional view illustrating a part of the water treatment device of the dishwasher according to an embodiment of the present disclosure, showing a state in which the first case and the second case are separated.

FIG. 18 is an enlarged cross-sectional view illustrating a part of the water treatment device of the dishwasher according to an embodiment of the present disclosure, showing a state in which the first case and the second case are coupled.

FIG. 19 is an enlarged cross-sectional view illustrating some configurations, such as a first terminal and a first deionization electrode, included in the water treatment device of the dishwasher according to an embodiment of the present disclosure.

FIG. 20 is an enlarged cross-sectional view illustrating some configurations, such as a second terminal and a second deionization electrode, included in the water treatment device of the dishwasher according to an embodiment of the present disclosure.

FIG. 21 is a perspective view illustrating a water treatment device of the dishwasher according to an embodiment of the present disclosure.

FIG. 22 is an exploded perspective view illustrating some configurations of the water treatment device of the dishwasher according to an embodiment of the present disclosure.

FIG. 23 is a cross-sectional view of the water treatment device of the dishwasher according to an embodiment of the present disclosure.

FIG. 24 is an enlarged cross-sectional view illustrating a part of the water treatment device of the dishwasher according to an embodiment of the present disclosure, showing a state in which a first case and a second case are separated.

FIG. 25 is an enlarged cross-sectional view illustrating a part of the water treatment device of the dishwasher according to an embodiment of the present disclosure, showing a state in which the first case and the second case are coupled.

### DETAILED DESCRIPTION OF THE EMBODIMENTS

Embodiments described in the disclosure and configurations shown in the drawings are merely examples of the embodiments of the disclosure and may be modified in various different ways at the time of filing of the present application to replace the embodiments and drawings of the disclosure.

In addition, the same reference numerals or signs shown in the drawings of the disclosure indicate elements or components performing substantially the same function.

Also, the terms used herein are used to describe the embodiments and are not intended to limit and/or restrict the disclosure. The singular forms “a,” “an” and “the” are intended to include the plural forms as well, unless the context clearly indicates otherwise. In this disclosure, the terms “including”, “having”, and the like are used to specify features, figures, steps, operations, elements, components, or combinations thereof, but do not preclude the presence or addition of one or more of the features, figures, steps, operations, elements, components, or combinations thereof.

It will be understood that, although the terms “first”, “second”, “primary”, “secondary”, etc., may be used herein to describe various elements, but elements are not limited by these terms. These terms are only used to distinguish one element from another element. For example, without departing from the scope of the disclosure, a first element may be termed as a second element, and a second element may be termed as a first element. The term of “and/or” includes a plurality of combinations of relevant items or any one item among a plurality of relevant items.

Hereinafter, embodiments of the disclosure will be described in detail with reference to the accompanying drawings.

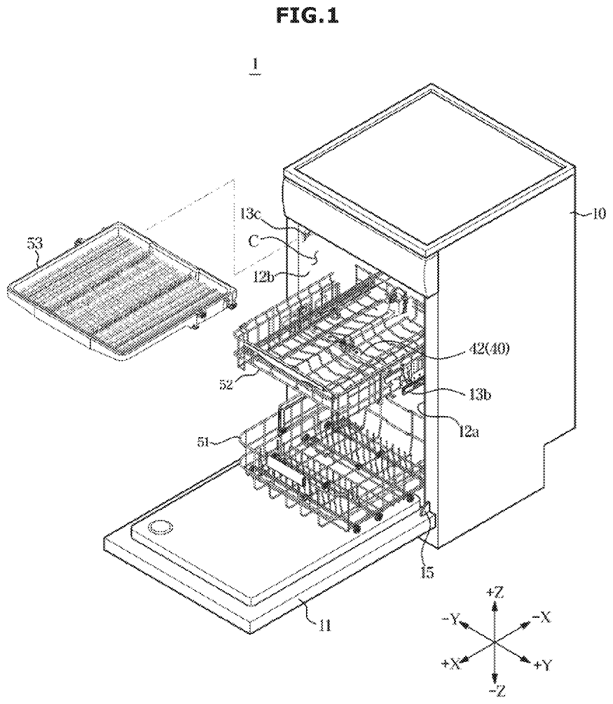

In describing various embodiments of the present disclosure with reference to FIGS. 1 to 25, terms such as “front”, “rear”, “upper”, “lower”, “up-and-down direction”, “left-to-right direction”, etc. used in the following description are defined based on the drawings, and the shape and position of each component are not limited by these terms. For example, the term “front-to-back direction” below may refer to a direction parallel to an X-axis based on the drawings, and “front” and “rear” may refer to a +X direction and a-X direction, respectively, based on the drawings. For example, “vertical direction (up-and-down direction)” may refer to a direction parallel to a Z-axis based on the drawings, and “upper” and “lower” may refer to a +Z direction and a-Z direction, respectively, based on the drawings. For example, the term “horizontal direction (left-to-right direction)” below may refer to a direction parallel to a Y-axis based on the drawings, and “left direction” and “right direction” may refer to a −Y direction and a +Y direction, respectively, based on the drawings.

With reference to FIGS. 1 to 25, a dishwasher will be described below as an example of an appliance that may include a water treatment device according to various embodiments of the present disclosure, but embodiments of the present disclosure are not limited thereto, and water treatment devices according to embodiments of the present disclosure may be included in a variety of appliances that have or require the function of receiving and treating raw water.

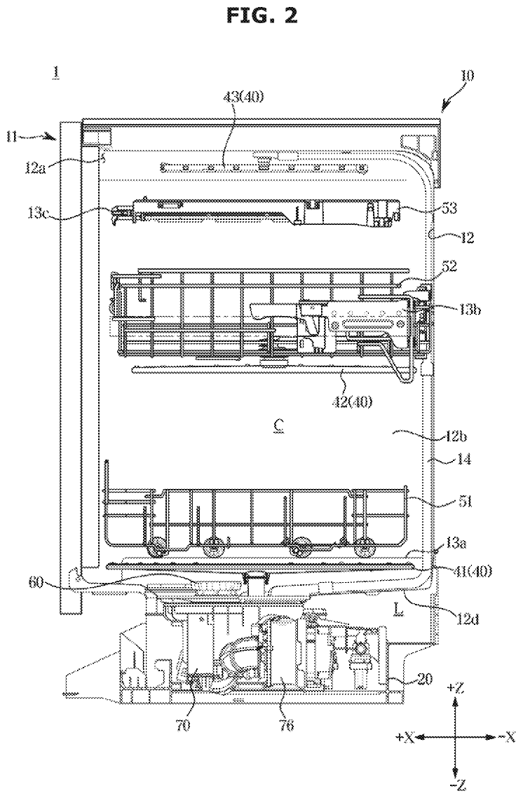

FIG. 1 is a perspective view of a dishwasher according to an embodiment of the present disclosure. FIG. 2 is a cross-sectional view of the dishwasher according to an embodiment of the present disclosure.

Referring to FIGS. 1 and 2, a dishwasher 1 according to an embodiment of the present disclosure may include a main body 10. The main body 10 may form an exterior of the dishwasher 1. Various configurations for operation of the dishwasher 1 may be disposed inside the main body 10.

The dishwasher 1 may include a tub 12. The tub 12 may be disposed inside the main body 10. The tub 12 may be coupled to an interior of the main body 10.

The tub 12 may include a washing chamber C. The washing chamber C may be formed inside the tub 12. The washing chamber C may be defined as an inner space of the tub 12. The washing chamber C may be defined as a space in which tableware is stored, washed, and/or dried.

The tub 12 may have an opening 12a. The opening 12a may be formed on one side of the tub 12. The washing chamber C formed inside the tub 12 may be opened on one side by the opening 12a. Tableware may be inserted into and stored in the washing chamber C or withdrawn from the washing chamber C through the opening 12a. For example, the opening 12a may be provided in the front (+X direction) of the tub 12. For example, the tub 12 may have a box shape with a substantially open front (+X direction).

The dishwasher 1 may include a door 11. The door 11 may be configured to open or close the tub 12. The door 11 may be configured to open or close the opening 12a of the tub 12. The door 11 may be configured to open or close the washing chamber C.

The door 11 may be mounted to the main body 10. For example, the door 11 may be mounted to a front surface of the main body 10. For example, the door 11 may be rotatably mounted to the main body 10. For example, the door 11 may be rotatably coupled to the main body 10 by a hinge 15.

For example, the hinge 15 may connect a lower portion of the door 11 to a lower portion of the main body 10. For example, the door 11 may be configured to be rotatable relative to the main body 10 about a rotation axis extending in the left-to-right direction (Y).

The dishwasher 1 may include a storage container configured to receive tableware. The storage container may be disposed inside the tub 12. The storage container may be disposed in the washing chamber C. For example, the storage container may be mounted to an inner wall of the tub 12. For example, the storage container may be mounted on a side wall 12b of the tub 12.

According to an embodiment, the storage container may include a plurality of baskets 51, 52, and 53. The plurality of baskets 51, 52, and 53 may be configured to accommodate a variety of tableware.

According to an embodiment, the storage container may include an intermediate basket 52. The intermediate basket 52 may be disposed at a substantially intermediate height in the up-and-down direction (Z-direction) of the dishwasher 1. The intermediate basket 52 may be inserted into or withdrawn from the washing chamber C through the opening 12a of the tub 12. For example, the intermediate basket 52 may be movable substantially in the front-to-back direction (X-direction) relative to the tub 12. For example, the intermediate basket 52 may be configured to be supported on an intermediate guide rack 13b. For example, the intermediate basket 52 may be configured to be slidably movable by the intermediate guide rack 13b. For example, the intermediate guide rack 13b may be installed inside each of the side walls 12b of the tub 12. However, the embodiment of the present disclosure is not limited thereto, and in various embodiments, the intermediate basket 52 may be supported by various configurations within the tub 12.

According to an embodiment, the storage container may include a lower basket 51. The lower basket 51 may be disposed at a substantially lower portion in the up-and-down direction (Z-direction) of the dishwasher 1. For example, the lower basket 51 may be disposed below the intermediate basket 52. The lower basket 51 may be inserted into or withdrawn from the washing chamber C through the opening 12a of the tub 12. For example, the lower basket 51 may be movable substantially in the front-to-back direction (X-direction) relative to the tub 12. For example, the lower basket 51 may be configured to be supported on a lower guide rack 13a. For example, the lower basket 51 may be configured to be slidably movable by the lower guide rack 13a. For example, the lower guide rack 13a may be installed inside the side wall 12b of the tub 12. However, the embodiment of the present disclosure is not limited thereto, and in various embodiments, the lower basket 51 may be supported by various configurations within the tub 12.

The lower basket 51 and the intermediate basket 52 may accommodate relatively bulky tableware. However, the types of tableware that may be stored in the lower basket 51 and the intermediate basket 52 may not be limited to relatively bulky tableware.

According to an embodiment, the storage container 50 may include an upper basket 53. The upper basket 53 may be disposed at a substantially upper portion in the up-and-down direction (Z-direction) of the dishwasher 1. In an example, the upper basket 53 may be formed in a rack assembly shape to accommodate relatively low bulky tableware. For example, the upper basket 53 may store cooking utensils or cutlery, such as ladles, knives, flippers, and the like. For example, the upper basket 53 may store small cups, such as espresso mugs. However, the types of tableware that may be stored in the upper basket 53 are not limited to the above examples.

The upper basket 53 may be inserted into or withdrawn from the washing chamber C through the opening 12a of the tub 12. For example, the upper basket 53 may be movable substantially in the front-to-back direction (X-direction) relative to the tub 12. The upper basket 53 may be configured to be supported on an upper guide rack 13c. For example, the upper basket 53 may be configured to be slidably movable by the upper guide rack 13c. For example, the upper guide rack 13c may be installed inside the side wall 12b of the tub 12. However, the embodiment of the present disclosure is not limited thereto, and in various embodiments, the upper basket 53 may be supported by various configurations within the tub 12.

While FIGS. 1 and 2 are described with reference to an embodiment in which the plurality of baskets 51, 52, and 53 are arranged in the up-and-down direction (Z-direction) relative to each other, embodiments of the present disclosure are not limited thereto, and in various embodiments, the storage container may include baskets arranged in various ways. The lower basket 51, the intermediate basket 52, and the upper basket 53 described above are defined and named for ease of description with reference to a relative position of each of the plurality of baskets 51, 52, and 53, and the expressions “lower”, “intermediate”, and “upper” do not limit the position of the baskets.

While FIGS. 1 and 2 are described with reference to an embodiment in which the storage container includes three baskets 51, 52, and 53, embodiments of the present disclosure are not limited thereto, and in various embodiments, the storage container may include only a single basket, or may include two or four or more baskets.

The dishwasher 1 may include a spraying device 40 (e.g., a sprayer). The spraying device 40 may be configured to spray washing water. The spraying device 40 may be configured to spray washing water into the interior of the tub 12. The spraying device 40 may be configured to spray washing water into the washing chamber C. The spraying device 40 may spray washing water toward the tableware stored in the washing chamber C. The spraying device 40 may be supplied with washing water from a sump 70, which will be described later. Here, the washing water may include water for washing tableware, and may include water mixed with a detergent and/or rinse, and water not mixed with detergent and/or rinse.

The spraying device 40 may include at least one spraying unit. For example, the spraying device 40 may include a plurality of spraying units 41, 42, and 43.

For example, the spraying device 40 may include a first spraying unit 41 disposed below the lower basket 51 in the up-and-down direction (Z-direction) of the dishwasher 1. For example, the spraying device 40 may include a second spraying unit 42 disposed above the lower basket 51 and below the intermediate basket 52 in the up-and-down direction (Z-direction) of the dishwasher 1. For example, the spraying device 40 may include a third spraying unit 43 disposed above the upper basket 53 in the up-and-down direction (Z-direction) of the dishwasher 1. However, embodiments of the present disclosure are not limited thereto, and in various embodiments, the spraying device 40 may include two or fewer or four or more spraying units.

Each of the plurality of spraying units 41, 42, and 43 may be configured to spray washing water while rotating. For example, the first spraying unit 41, the second spraying unit 42, and the third spraying unit 43 may each be configured to spray washing water while rotating. The plurality of spraying units 41, 42, and 43 may be referred to as a plurality of spraying rotors 41, 42, and 43. The first spraying unit 41, the second spraying unit 42, and the third spraying unit 43 may be referred to as a first spraying rotor 41, a second spraying rotor 42, and a third spraying rotor 43, respectively.

However, in various embodiments, the spraying device 40 may spray washing water in a manner different from the example described above. For example, the first spraying unit 41, unlike the second spraying unit 42 and the third spraying unit 43, may be fixed to one side of a bottom surface 12d of the tub 12. In this case, the first spraying unit 41 may be configured to spray washing water in a substantially horizontal direction by a fixed nozzle, and the washing water sprayed in the substantially horizontal direction from the nozzle of the first spraying unit 41 may be redirected by a diversion assembly disposed inside the washing chamber C and directed upwardly. The diversion assembly may be mounted on a rail and may be configured to be translationally movable along the rail. Meanwhile, although the first spraying unit 41 has been described as an example, the second spraying unit 42 and the third spraying unit 43 may also be configured to spray washing water using fixed nozzles, as in the examples described above.

The dishwasher 1 may include a sump 70. The sump 70 may be configured to receive washing water. For example, the sump 70 may be configured to receive washing water to be supplied to the spraying device 40. For example, the sump 70 may provide washing water to at least one of the plurality of spraying units 41, 42, and 43. For example, the sump 70 may selectively supply washing water to the plurality of spraying units 41, 42, and 43.

The sump 70 may be configured to store washing water in the tub 12. The sump 70 may be configured to collect washing water from the washing chamber C. In an example, to facilitate smooth collection of washing water by the sump 70, the bottom surface 12d of the tub 12 may be inclined downwardly toward the sump 70. Washing water from the washing chamber C may flow down along the slope of the bottom surface 12d of the tub 12 and smoothly enter the sump 70.

The dishwasher 1 may include a circulation pump 76 configured to pump the washing water stored in the sump 70. The circulation pump 76 may pump the washing water stored in the sump 70 and provide the pumped washing water to the spraying device 40. According to an embodiment, the circulation pump 76 may be provided as one configuration of the sump 70. The circulation pump 76 may be disposed in a machine chamber L.

The dishwasher 1 may include a pipe 14. The pipe 14 may connect the sump 70 and the spraying device 40. The pipe 14 may connect the sump 70 and the plurality of spraying units 41, 42, and 43. The pipe 14 may be configured to guide washing water from the sump 70 to the spraying device 40. The pipe 14 may be configured to guide washing water from the sump 70 to the plurality of spraying units 41, 42, and 43. In an example, the pipe 14 may include a shape extending substantially in the up-and-down direction (Z-direction).

The dishwasher 1 may include the machine chamber L. The machine chamber L may be a space disposed below the tub 12. The machine chamber L may be disposed below the washing chamber C. The machine chamber L may be partitioned from the washing chamber C. The dishwasher 1 may include a base frame 20 that forms the machine chamber L. The base frame 20 may be mounted to a lower portion of the main body 10. The base frame 20 may be mounted to a lower portion of the tub 12. In the machine chamber L, a configuration for circulating washing water may be disposed.

At least a portion of the sump 70 may be disposed in the machine chamber L. For example, a majority of the sump 70 may be disposed in the machine chamber L. For example, a volume of the sump 70 that is disposed in the washing chamber C may be smaller than a volume of the sump 70 that is disposed in the machine chamber L. By reducing the volume of the sump 70 that occupies the washing chamber C, a space inside the washing chamber C may be secured. Thus, the capacity of the washing chamber C may be increased, thereby improving the storage capacity of tableware.

The dishwasher 1 may include a filter 60. The filter 60 may be configured to filter out foreign matter contained in the washing water entering the sump 70. The washing water filtered by the filter 60 may be delivered to the spraying device 40 by the sump 70. The filter 60 may be detachably mounted to the sump 70. At least a portion of the filter 60 may be disposed inside the sump 70. For example, the filter 60 may include at least one of a fine filter, a coarse filter, or a micro filter.

The configurations of the dishwasher 1 described above with reference to FIGS. 1 and 2 are merely one embodiment of the present disclosure, and in various embodiments, the dishwasher 1 may include various configurations necessary to perform various functions, such as washing and/or drying tableware.

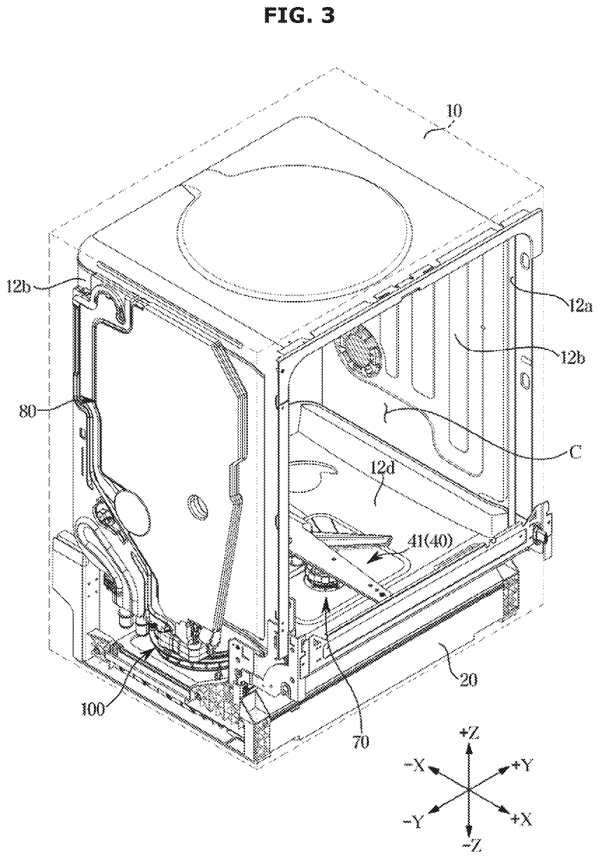

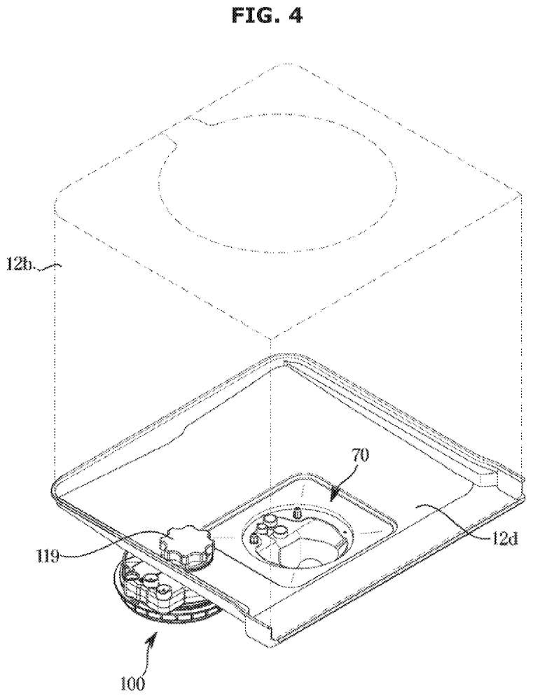

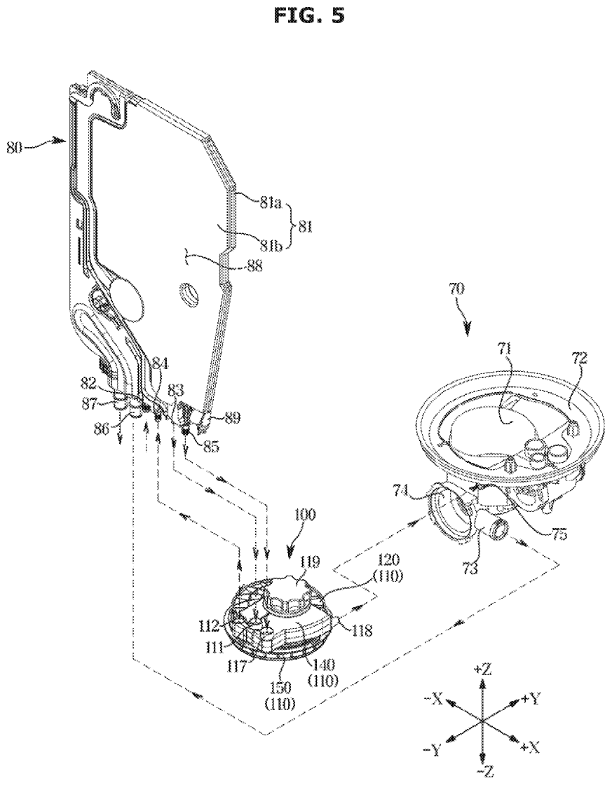

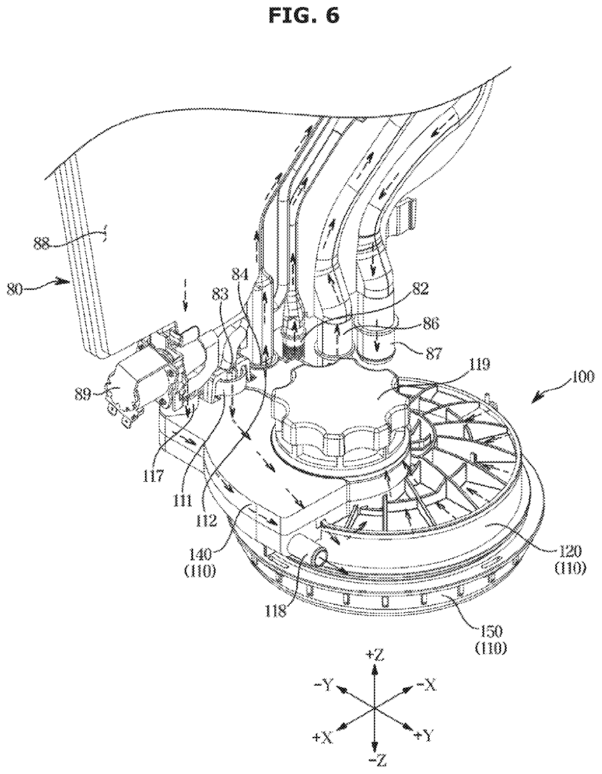

FIG. 3 is a perspective view illustrating various configurations disposed inside a main body of the dishwasher according to an embodiment of the present disclosure. FIG. 4 is a perspective view illustrating a tub, and a sump and a water treatment device mounted to the tub of the dishwasher according to an embodiment of the present disclosure. FIG. 5 is a diagram illustrating a connection relationship and a flow of washing water between the sump, a case break, and the water treatment device of the dishwasher according to an embodiment of the present disclosure. FIG. 6 is a perspective view illustrating the case break and the water treatment device of the dishwasher according to an embodiment of the present disclosure.

Referring to FIGS. 3 to 6, the dishwasher 1 according to an embodiment of the present disclosure may include a water treatment device 100. The water treatment device 100 may be configured to perform water treatment on washing water. The water treatment device 100 may be configured to treat washing water to be supplied to the spraying device 40. The water treatment device 100 may be configured to treat washing water to be supplied to the sump 70. A flow path through which water flows may be formed in the water treatment device 100.

The water treatment device 100 may be configured to treat raw water provided from a water source. According to an embodiment, the raw water provided from the water source may include hard water having a relatively high percentage of ionic substances, and the water treatment device 100 may be configured to remove the ionic substances from the raw water and convert the raw water into soft water. The water treatment device 100 may be configured to provide soft water, from which ionic substances have been removed from the raw water, to the sump 70. In other words, the water treatment device 100 may soften the washing water. In addition, the water treatment device 100 may treat the washing water in various ways.

According to an embodiment, the water treatment device 100 may include a capacitive deionization (CDI) unit.

The water treatment device 100 may include an inlet port 111. The inlet port 111 may be configured to allow raw water to enter the water treatment device 100. For example, raw water from a case break 80, which will be described later, may be introduced into the water treatment device 100 via the inlet port 111.

The water treatment device 100 may include an outlet port 112. The outlet port 112 may be configured to allow treated water (e.g., soft water) that has passed through the water treatment device 100 to be discharged from the water treatment device 100. For example, the water treated by the water treatment device 100 may be supplied to the case break 80 via the outlet port 112.

The water treatment device 100 may include a tank connection port 117 and a sump connection port 118. The tank connection port 117 may be connected to a water tank 88, which will be described later. The sump connection port 118 may be connected to the sump 70. For example, the washing water stored in the water tank 88, which will be described later, may be introduced into the water treatment device 100 through the tank connection port 117, and the washing water introduced into the water treatment device 100 may be discharged through the sump connection port 118 and fed into the sump 70.

The water treatment device 100 may be accommodated within the main body 10. For example, the water treatment device 100 may be disposed on a lower side of the tub 12. For example, at least a portion of the water treatment device 100 may be disposed below the bottom surface 12d of the tub 12. For example, at least a portion of the water treatment device 100 may be disposed in the machine chamber L.

A detailed description of the water treatment device 100 will be described later.

According to an embodiment, the dishwasher 1 may include the case break 80. The case break 80 may include various flow paths through which water flows. For example, the case break 80 may include a flow path through which raw water provided from a water source flows. For example, the case break 80 may include a flow path through which washing water (e.g., soft water) that has passed through the water treatment device 100 flows. For example, the case break 80 may include a flow path through which water collected and drained by the sump 70 after a washing process flows.

The case break 80 may be connected to configuration such as a water source, the water treatment device 100, and the sump 70. For example, the case break 80 may be connected to a water source to receive raw water from the water source. For example, the case break 80 may be connected to the water treatment device 100 to supply raw water to the water treatment device 100 and receive treated washing water (e.g., soft water) from the water treatment device 100. For example, the case break 80 may be connected to the sump 70 to supply washing water to the sump 70. For example, the case break 80 may be connected to the water treatment device 100 to supply washing water to the water treatment device 100, and the washing water may pass through the water treatment device 100 and be supplied to the sump 70. For example, the case break 80 may be connected to the sump 70 to receive water collected and drained by the sump 70 after a washing process and then discharge the water to the outside of the main body 10. For example, the case break 80 may be connected to configurations, such as the water source, the water treatment device 100, and the sump 70, by a hose.

The case break 80 may include a raw water inlet 82. The raw water inlet 82 may be configured to allow raw water to be introduced into the case break 80. For example, the raw water inlet 82 may be connected to a water source, and the raw water provided from the water source may flow through the raw water inlet 82 into the case break 80.

The case break 80 may include a raw water outlet 83. The raw water outlet 83 may be configured to allow raw water within the case break 80 to be discharged. For example, the raw water outlet 83 may be connected to the water treatment device 100 (e.g., the inlet port 111), and the raw water within the case break 80 may be discharged through the raw water outlet 83 and fed to the water treatment device 100.

The case break 80 may include a soft water inlet 84. The soft water inlet 84 may be configured to allow soft water treated by the water treatment device 100 to be introduced into the case break 80. For example, the soft water inlet 84 may be connected to the water treatment device 100 (e.g., the outlet port 112), and the soft water treated and discharged by the water treatment device 100 may be fed into the case break 80 via the soft water inlet 84.

The case break 80 may include a soft water outlet 85. The soft water outlet 85 may be configured to allow soft water (e.g., washing water stored in the water tank 88) within the case break 80 to be discharged. For example, the soft water outlet 85 may be connected to the water treatment device 100 (e.g., the tank connection port 117), and the soft water discharged through the soft water outlet 85 may be introduced into the water treatment device 100 and then supplied to the sump 70. Alternatively, for example, the soft water outlet 85 may be directly connected to the sump 70 (e.g., a sump inlet 75), and the soft water discharged through the soft water outlet 85 may be directly supplied to the sump 70.

The case break 80 may include a drain inlet 86. The drain inlet 86 may be configured to allow water discharged from the washing chamber C to flow into the case break 80 after a washing process is completed. For example, the drain inlet 86 may be connected to the sump 70 (e.g., a sump drain 73), and the water discharged from the washing chamber C may be collected in the sump 70, drained therefrom, and enter the case break 80 through the drain inlet 86.

The case break 80 may include a drain outlet 87. The drain outlet 87 may be configured to allow water entering the case break 80 through the drain inlet 86 to be discharged. For example, the drain outlet 87 may be connected to the outside of the main body 10, and the water entering the case break 80 through the drain inlet 86 may be drained to the outside of the main body 10 through the drain outlet 87.

The case break 80 may be accommodated within the main body 10. For example, the case break 80 may be disposed between the tub 12 and the main body 10. For example, the case break 80 may be coupled to the side wall 12b of the tub 12. For example, the case break 80 may be coupled to an outer surface of the side wall 12b of the tub 12. While FIGS. 3 to 6 illustrate an embodiment in which the case break 80 is coupled to a left wall of the tub 12 disposed in a left direction (−Y direction), the position on the tub 12 to which the case break 80 is coupled may not be limited thereto.

The case break 80 may include a case body 81. The case body 81 may form an exterior of the case break 80. The case body 81 may form a flow path for water to flow therein. The case body 81 may form a reservoir space S in which water (e.g., soft water) is stored therein. The case body 81 may be coupled to the side wall 12b of the tub 12.

In an embodiment, the case body 81 may include a first case body 81a and a second case body 81b. The first case body 81a and the second case body 81b may be coupled to each other. A flow path through which water flows (e.g., an air break) may be formed between the first case body 81a and the second case body 81b. A reservoir space (e.g., the water tank 88) may be formed between the first case body 81a and the second case body 81b. In an example, the first case body 81a may be coupled to the side wall 12b of the tub 12, and the second case body 81b may be disposed between the main body 10 and the first case body 81a and coupled to the first case body 81a.

The raw water inlet 82, the raw water outlet 83, the soft water inlet 84, the drain inlet 86, and the drain outlet 87 described above may each be connected to an interior of the case body 81. The raw water inlet 82, the raw water outlet 83, the soft water inlet 84, the drain inlet 86, and the drain outlet 87 described above may each be connected to a space between the first case body 81a and the second case body 81b.

According to an embodiment, the case break 80 may include an air break configured to prevent washing water flowing along a flow path inside the case break 80 from flowing in reverse into the water treatment device 100. The air break may be formed as a flow path through which water flows inside the case body 81. The air break may be connected to at least a portion of the water source, the water treatment device 100, and the sump 70.

According to an embodiment, the case break 80 may include an air break hole configured to connect a flow path inside the case break 80 with the outside. The air break hole may allow pressure equalization between the inside and/or the internal flow path of the case break 80 and the atmosphere.

The air break may be configured to prevent backflow of washing water due to a siphon phenomenon in the event that water supply is interrupted.

The air break may be configured to cause water to flow toward the tub 12 when more than a predetermined hydraulic pressure or flow rate of water is introduced into the case break 80. According to an embodiment, the case break 80 may include a flowmeter. For example, the flowmeter may be disposed adjacent to the raw water inlet 82 and configured to detect a flow rate of raw water being supplied. The case break 80 may control the amount of water supply based on the flow rate of raw water detected by the flowmeter.

The case break 80 may include the water tank 88. The water tank 88 may include a reservoir space for storing washing water therein. The water tank 88 may store soft water treated by the water treatment device 100. The water tank 88 may be connected to a flow path through which washing water flows inside the case break 80. The water tank 88 may be connected to the air break. Soft water introduced into the case break 80 through the soft water inlet 84 may be supplied to the water tank 88 and stored in the water tank 88. For example, the water tank 88 may be connected to a flow path for soft water inside the case break 80 to flow at an upper portion of the case break 80.

The soft water outlet 85 described above may be connected to the water tank 88. The washing water stored in the water tank 88 may be discharged from the water tank 88 through the soft water outlet 85.

According to an embodiment, to adjust the amount of washing water supplied from the water tank 88 to the sump 70 and/or the water treatment device 100, the case break 80 may include a valve 89 configured to open or close the soft water outlet 85. The valve 89 may include various types of valves, such as a solenoid valve.

According to an embodiment, the case break 80 may be formed by integrating the water tank 88 with the flow path inside the case break 80 including the air break. However, the present disclosure is not limited thereto, and in various embodiments, the water tank 88 may be formed in a separate configuration separate from the case break 80, and in this case, the flow path inside the case break 80 and the water tank 88 may be connected to each other via a connecting member such as a hose, a pipe, or the like.

According to an embodiment, the sump 70 may include a collecting portion 71. In an example, the collecting portion 71 may collect washing water that has passed through the water treatment device 100 and the case break 80 in sequence. In an example, the collecting portion 71 may collect the washing water discharged from the water tank 88. In an example, the collecting portion 71 may collect the water discharged from the washing chamber C. The collecting portion 71 may include an opening to collect water. The collecting portion 71 may be provided on one side of the sump 70 facing the tub 12.

According to an embodiment, the sump 70 may include a seating portion 72. The bottom surface 12d of the tub 12 may be seated on the seating portion 72. The seating portion 72 may be coupled to the tub 12.

According to an embodiment, the sump 70 may include the sump drain 73. The sump drain 73 may be configured to drain the water collected in the collecting portion 71 (e.g., water discharged from the washing chamber C after the washing process is completed). The sump drain 73 may discharge water to the drain inlet 86 of the case break 80.

In an example, the sump drain 73 may be provided with a check valve. The check valve may reduce the backflow of water. For example, the check valve may be disposed at one end of the sump drain 73.

According to an embodiment, the sump 70 may include a drain pump coupling portion 74. The drain pump coupling portion 74 may be provided with a drain pump for pumping water to drain the collected water after the washing process.

According to an embodiment, the sump 70 may include the sump inlet 75. In an example, the sump inlet 75 may be connected to at least a portion of the sump connection port 118 or the soft water outlet 85 via a hose or the like. The washing water discharged from the case break 80 (e.g., the water tank 88) and/or the water treatment device 100 may flow to the sump 70 through the sump inlet 75. The water flowing to the sump 70 may be collected in the collecting portion 71.

In an example, the sump inlet 75 may be configured such that washing water that has passed through the water treatment device 100 and the case break 80 in turn is collected in the sump 70. In an example, the sump inlet 75 may be configured such that washing water that has passed through the water tank 88 in turn is collected in the sump 70.

In the following, an overall flow of water flowing along the case break 80, the water treatment device 100, and the sump 70 will be described as an example with reference to FIGS. 5 and 6.

Raw water supplied from various water sources provided outside the main body 10 or the like may be introduced into the case break 80 via the raw water inlet 82. The raw water entering through the raw water inlet 82 may pass through the case break 80, be discharged through the raw water outlet 83, and then be introduced into the water treatment device 100 through the inlet port 111. The raw water entering the water treatment device 100 may be treated through the water treatment device 100 to become soft water, and the treated soft water may be discharged from the water treatment device 100 through the outlet port 112. The soft water discharged through the outlet port 112 may be introduced back into the case break 80 through the soft water inlet 84. Soft water may flow along a flow path (e.g., the air break) inside the case break 80 and be introduced into and stored in the water tank 88. However, embodiments of the present disclosure are not limited thereto, and in various embodiments, the soft water discharged through the outlet port 112 may be directly introduced into the water tank 88 without passing through the flow path inside the case break 80. The soft water stored in the water tank 88 may be discharged through the soft water outlet 85 for delivery to the sump 70. The soft water discharged through the soft water outlet 85 may be introduced into the water treatment device 100 through the tank connection port 117, then discharged from the water treatment device 100 through the sump connection port 118, and supplied to the sump inlet 75. However, embodiments of the present disclosure are not limited thereto, and in various embodiments, the soft water discharged through the soft water outlet 85 may be directly supplied to the sump inlet 75 without passing through the water treatment device 100. The soft water supplied to the sump inlet 75 may be collected in the collecting portion 71 and supplied to the spraying device 40.

However, the connection relationship of the case break 80, the water treatment device 100, and the sump 70 described above is merely an example for describing embodiments of the present disclosure, and in various embodiments of the present disclosure, the case break 80, the water treatment device 100, and the sump 70 may be connected/coupled in various ways to supply or receive water from each other.

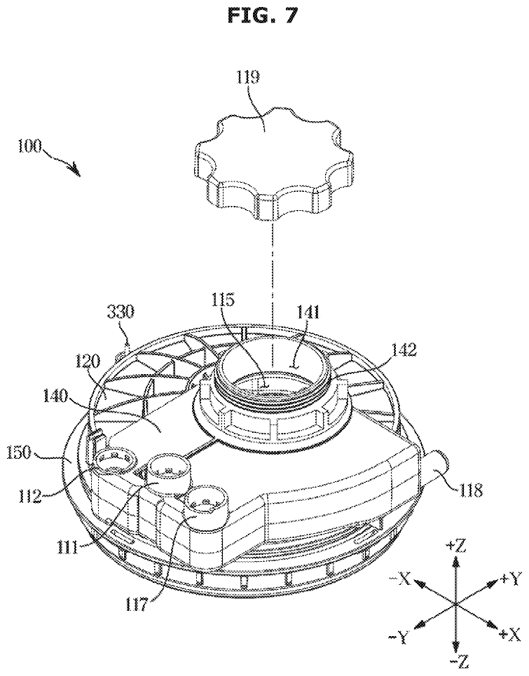

Hereinafter, the structure and operation of the water treatment device 100 according to various embodiments of the present disclosure will be described in more detail with reference to FIGS. 7 to 25.

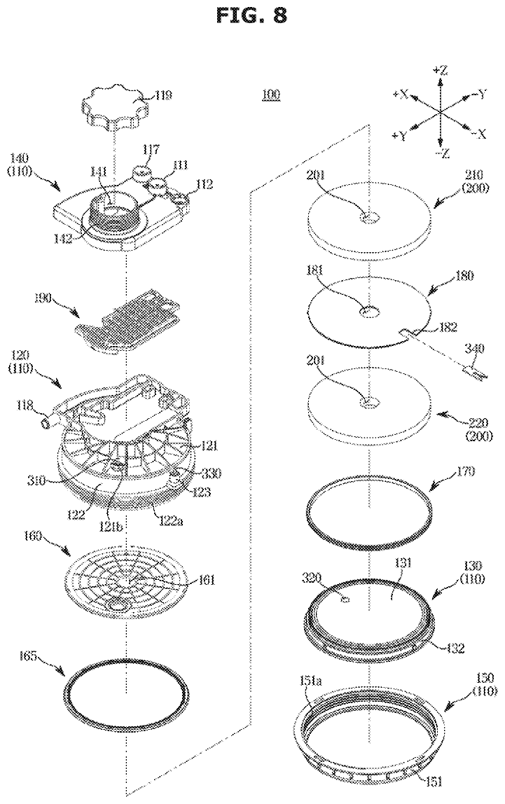

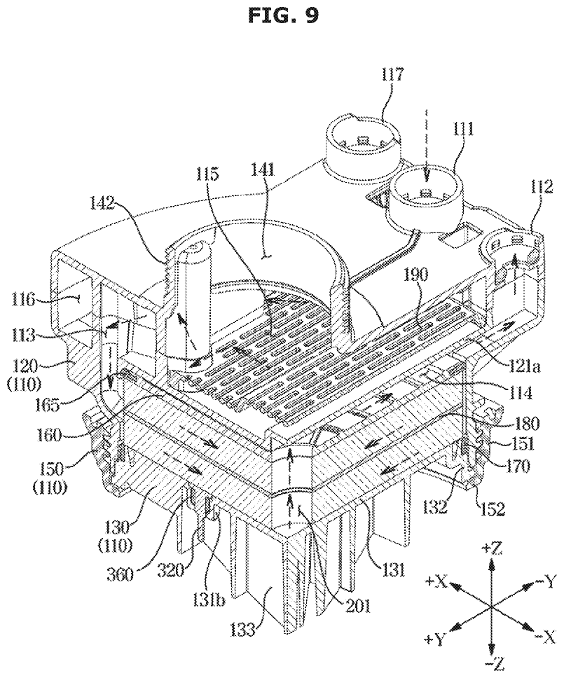

FIG. 7 is a perspective view illustrating the water treatment device of the dishwasher according to an embodiment of the present disclosure. FIG. 8 is an exploded perspective view illustrating the water treatment device of the dishwasher according to an embodiment of the present disclosure. FIG. 9 is a cross-sectional perspective view illustrating the water treatment device of the dishwasher according to an embodiment of the present disclosure.

Referring to FIGS. 7 to 9, the water treatment device 100 of the dishwasher 1 according to an embodiment of the present disclosure may be configured to treat washing water for supply to the sump 70. For example, the water treatment device 100 may be configured to soften water by adsorbing and removing ionic substances from the water passing through the water treatment device 100.

The water treatment device 100 may include the case 110. The case 110 may form an overall exterior of the water treatment device 100. Various configurations of the water treatment device 100, including a deionization electrode 200, may be accommodated within the case 110.

The case 110 may include the inlet port 111 described above. Water (e.g., raw water) may be introduced into the case 110 through the inlet port 111. In an example, the inlet port 111 may be disposed on the upper portion of the case 110. In an example, the inlet port 111 may be formed on an upper surface of the case 110. In an example, the inlet port 111 may have a shape that penetrates the upper surface of the case 110 in the vertical direction (Z-direction). In an example, water may pass through the inlet port 111 in the vertically downward direction (−Z direction) and flow into the interior of the case 110. However, embodiments of the present disclosure are not limited thereto, and the inlet port 111 may be formed at various positions on the case 110.

The case 110 may include outlet port 112 described above. Water (e.g., soft water) may be discharged to the outside of the case 110 through the outlet port 112. In an example, the outlet port 112 may be disposed on the upper portion of the case 110. The outlet port 112 may be formed on the upper surface of the case 110. In an example, the outlet port 112 may have a shape that penetrates the upper surface of the case 110 in the vertical direction (Z-direction). In an example, water may be discharged from the case 110 by passing through the outlet port 112 in the vertically upward direction (+Z direction). However, embodiments of the present disclosure are not limited thereto, and the outlet port 112 may be formed at various positions on the case 110.

A flow path extending between the inlet port 111 and the outlet port 112 may be formed inside the case 110. Raw water from the inlet port 111 may flow along the flow path inside the case 110 and be softened by removing ions, and the deionized soft water may be discharged through the outlet port 112. For example, an inflow path 113 through which water supplied through the inlet port 111 flows toward the deionization electrode 200, which will be described later, may be formed inside the case 110. The inflow path 113 may extend between the inlet port 111 and the deionization electrode 200. For example, an outflow path 114 through which water passing through the deionization electrode 200 flows toward the outlet port 112 may be formed inside the case 110. The outflow path 114 may extend between the deionization electrode 200 and the outlet port 112.

The case 110 may include the tank connection port 117 and the sump connection port 118 described above. Water supplied from the water tank 88 may be introduced into the case 110 through the tank connection port 117 and discharged from the case 110 through the sump connection port 118 to be supplied to the sump 70. A supply flow path 116 extending between the tank connection port 117 and the sump connection port 118 may be formed inside the case 110.

In an example, the tank connection port 117 may be formed on the upper portion of the case 110. In an example, the tank connection port 117 may be formed on the upper surface of the case 110. In an example, the tank connection port 117 may have a shape that penetrates the upper surface of the case 110 in the vertical direction (Z-direction). In an example, water may be introduced into the supply flow path 116 by passing through the tank connection port 117 in the vertically downward direction (−Z direction). In an example, the sump connection port 118 may be formed on the upper portion of the case 110. In an example, the sump connection port 118 may be disposed below the tank connection port 117 or at a substantially parallel position in the vertical direction (Z-direction). In an example, the sump connection port 118 may have a shape that penetrates the case 110 in the horizontal direction (e.g., the left-to-right direction (Y)). In an example, water may be supplied to the sump 70 by passing through the sump connection port 118 in a rightward direction (+Y direction) and being discharged from the supply flow path 116. However, embodiments of the present disclosure are not limited thereto, and the tank connection port 117 and the sump connection port 118 may each be formed at various positions on the case 110.

A receiving portion 115 may be formed inside the case 110. The receiving portion 115 may be provided in the inflow path 113. The receiving portion 115 may be configured to receive a regeneration material for removing ions adsorbed on the deionization electrode 200.

In an example, the case 110 may include a supply opening 141. The supply opening 141 may be configured to connect the receiving portion 115 to the outside of the case 110. In an example, the supply opening 141 may connect the receiving portion 115 and the outside of the case 110 at an upper side of the receiving portion 115. In an example, the receiving portion 115 may be open in an upward direction (+Z direction). A regeneration material may be input into the receiving portion 115 via the supply opening 141.

In an example, the water treatment device 100 may include a cap 119 configured to open or close the supply opening 141. The case 110 may include a cap coupling portion 142, and the cap 119 may be detachably coupled to the cap coupling portion 142. The supply opening 141 may be closed when the cap 119 is coupled to the cap coupling portion 142, and the supply opening 141 may be open when the cap 119 is detached from the cap coupling portion 142. In an example, when the cap 119 is coupled to the cap coupling portion 142, the cap 119 may be positioned inside the tub 12 (e.g., in a lower portion of the washing chamber C).

According to an embodiment, the water treatment device 100 may include a filter 190 provided in the inflow path 113. The filter 190 may be disposed in the flow path between the inlet port 111 and the deionization electrode 200. The filter 190 may be configured to filter out foreign matter from the raw water introduced through the inlet port 111. In an example, the filter 190 may be disposed in the receiving portion 115.

The water treatment device 100 may include the deionization electrode 200. The deionization electrode 200 may be disposed inside the case 110. The deionization electrode 200 may be disposed in a flow path inside the case 110 extending from the inlet port 111 toward the outlet port 112.

The deionization electrode 200 may be configured to allow water to pass therethrough. Water flowing into the case 110 through the inlet port 111 may flow through the deionization electrode 200 and toward the outlet port 112.

The deionization electrode 200 may be configured to remove ions from the water passing through the deionization electrode 200. The deionization electrode 200 may be configured to adsorb ionic substances from the water flowing into the case 110 through the inlet port 111. The deionization electrode 200 may adsorb ionic substances from the water passing through the deionization electrode 200 when a voltage is applied. Water from which ionic substances is removed by the deionization electrode 200 may become soft water and flow to the outlet port 112.

According to an embodiment, water flowing along the inflow path 113 may flow into a circumferential surface of the deionization electrode 200. At least a portion of the circumferential surface of the deionization electrode 200 may face one end of the inflow path 113 adjacent to the deionization electrode 200. Water flowing into the circumferential surface of the deionization electrode 200 may be treated and softened as it passes through the deionization electrode 200.

According to an embodiment, the deionization electrode 200 may include a hollow 201. The hollow 201 of the deionization electrode 200 may be connected to the outflow path 114. Water that passes through the deionization electrode 200 after entering the circumferential surface of the deionization electrode 200 may be discharged through the hollow 201 and flow toward the outflow path 114.

The hollow 201 may be disposed at a substantial center of the deionization electrode 200. In an example, the hollow 201 may be disposed to pass through the center of the deionization electrode 200 substantially in the first direction (Z-direction). In an example, the hollow 201 may extend substantially in the first direction (Z-direction). Water discharged from the deionization electrode 200 through the hollow 201 may flow in the first direction (Z-direction) and move to the outflow path 114. In an example, water discharged from the deionization electrode 200 through the hollow 201 may flow in the upward direction (+Z direction) and move to the outflow path 114. The water moved to the outflow path 114 may flow along the outflow path 114 and be discharged from the case 110.

In an example, the deionization electrode 200 may have a cylinder shape with the substantial hollow 201.

The deionization electrode 200 may include a conductive material. For example, the deionization electrode 200 may include a plurality of electrode layers including a conductive material, and the plurality of electrode layers may be stacked on top of each other. The plurality of electrode layers included in the deionization electrode 200 may be stacked in the first direction (Z-direction). For example, the plurality of electrode layers included in the deionization electrode 200 may be stacked in the substantially vertical direction (Z-direction). The deionization electrode 200 may include a capacitive deionization (CDI) electrode formed by stacking a plurality of electrode layers.

In an example, the plurality of electrode layers included in the deionization electrode 200 may include a porous carbon electrode, such as graphite. However, embodiments of the present disclosure are not limited thereto, and the deionization electrode 200 may include various conductive materials.

Dielectric polarization may occur in each of the plurality of electrode layers included in the deionization electrode 200 when a voltage is applied. Water flowing inside the case 110 may pass between the plurality of electrode layers, and the dielectrically polarized plurality of electrode layers may adsorb ionic substances from the water passing therethrough.

According to an embodiment, the deionization electrode 200 may include a plurality of deionization electrodes 210 and 220. The plurality of deionization electrodes 210 and 220 may be stacked on top of each other. For example, the plurality of deionization electrodes 210 and 220 may be arranged in the first direction (Z-direction). For example, the plurality of deionization electrodes 210 and 220 may be stacked in the first direction (Z-direction).

The plurality of deionization electrodes 200 may include a first deionization electrode 210 and a second deionization electrode 220. In an example, the first deionization electrode 210 may be disposed above the second deionization electrode 220. A voltage may be applied to each of the first deionization electrode 210 and the second deionization electrode 220, and each may soften water based on the applied voltage. The first deionization electrode 210 and the second deionization electrode 220 may have a shape corresponding to each other. The first deionization electrode 210 and the second deionization electrode 220 may each have the hollow 201.

While FIGS. 8 and 9 illustrates an embodiment in which the deionization electrodes 200 are provided in two, the number of deionization electrodes 200 in the embodiment of the present disclosure is not limited thereto. In various embodiments, the deionization electrode 200 may include three or more deionization electrodes arranged in the first direction (Z-direction) as well as two deionization electrodes 210 and 220. In various embodiments, the deionization electrode 200 may be provided in a single unit. Meanwhile, that the deionization electrode 200 is single here is not limited to the meaning that the deionization electrode 200 is configured as a single layer, and a single deionization electrode 200 may include a plurality of electrode layers stacked as described later.

According to an embodiment of the present disclosure, the dishwasher 1 may include terminals 310, 320, 330 and 340. The terminals 310, 320, 330 and 340 may be configured to apply a voltage to the deionization electrode 200. The terminals 310, 320, 330 and 340 may be electrically connected to the deionization electrode 200. The terminals 310, 320, 330 and 340 may be connected to an external power source or a separate power supply provided in the dishwasher 1, and the deionization electrode 200 may receive a voltage applied through the terminals 310, 320, 330 and 340. Each of the terminals 310, 320, 330 and 340 may include a conductive material.

A detailed description of steps by which the deionization electrode 200 is applied a voltage to adsorb ionic substances from water, and the structure and operation of the terminals 310, 320, 330 and 340 for applying a voltage to the deionization electrode 200 will be described later.

In the following, a detailed structure of the water treatment device 100 according to an embodiment will be described in more detail by way of example.

According to an embodiment, the case 110 of the water treatment device 100 may include a first case 120. The first case 120 may cover a portion of the deionization electrode 200.

The first case 120 may include a first horizontal cover portion 121 that covers one surface of the deionization electrode 200. The first horizontal cover portion 121 may cover one surface extending in the horizontal direction of the deionization electrode 200. The first horizontal cover portion 121 may cover one flat surface of the deionization electrode 200. For example, the first horizontal cover portion 121 may cover an upper surface of the deionization electrode 200. The first horizontal cover portion 121 may form an upper surface of the first case 120.

The first case 120 may include a circumferential cover portion 122 that covers a circumferential surface of the deionization electrode 200. For example, the circumferential cover portion 122 may extend from a rim of the first horizontal cover portion 121. For example, the circumferential cover portion 122 may extend in the downward direction (−Z direction) from the first horizontal cover portion 121. The circumferential cover portion 122 may form a circumferential surface of the first case 120.

According to an embodiment, the circumferential cover portion 122 may cover at least a portion of the second case 130. The circumferential cover portion 122 may cover at least a portion of an outer surface of the second case 130. The second case 130 may contact an inner surface of the circumferential cover portion 122.

According to an embodiment, at least a portion of the circumferential cover portion 122 may be disposed between a case coupling portion 151 and a circumferential wall 132, which will be described later.

The first case 120 may include a terminal accommodating portion 123 protruding outwardly from the circumferential cover portion 122. The terminal accommodating portion 123 may protrude from the circumferential cover portion 122 in the second direction (X-direction) different from the first direction (Z-direction). In an example, the terminal accommodating portion 123 may protrude in a rearward direction (−X direction) from the circumferential cover portion 122.

In an example, the inlet port 111 may be connected to the first case 120. In an example, the outlet port 112 may be connected to the first case 120. In an example, the tank connection port 117 may be connected to the first case 120. In an example, the sump connection port 118 may be included in the first case 120.

According to an embodiment, the case 110 may include a second case 130. The second case 130 may cover a portion of the deionization electrode 200. The second case 130 may cover a portion of the deionization electrode 200 that is different from the portion of the deionization electrode 200 covered by the first case 120.

The second case 130 may include a second horizontal cover portion 131 that covers one surface of the deionization electrode 200. The second horizontal cover portion 131 may cover one surface extending in the horizontal direction of the deionization electrode 200. The second horizontal cover portion 131 may cover one flat surface of the deionization electrode 200. For example, the second horizontal cover portion 131 may cover a lower surface of the deionization electrode 200. In an example, the second horizontal cover portion 131 may contact the deionization electrode 200. The second horizontal cover portion 131 may form an upper surface of the second case 130. In an example, the second horizontal cover portion 131 may be disposed opposite the first horizontal cover portion 121.

The second case 130 may include the circumferential wall 132. For example, the circumferential wall 132 may extend from a rim of the second horizontal cover portion 131. For example, the circumferential wall 132 may extend in the downward direction (−Z direction) from the second horizontal cover portion 131. The circumferential wall 132 may form a circumferential surface of the second case 130.

According to an embodiment, the circumferential cover portion 122 of the first case 120 and the circumferential wall 132 of the second case 130 may contact each other. For example, an inner surface of the circumferential cover portion 122 and an outer surface of the circumferential wall 132 may contact each other.

The second case 130 may include a plurality of ribs 133 protruding from the second horizontal cover portion 131. The plurality of ribs 133 may be configured to increase the rigidity of the second case 130. For example, the plurality of ribs 133 may protrude in an outward direction of the second case 130 from the second horizontal cover portion 131. For example, the plurality of ribs 133 may protrude in the downward direction (−Z direction) from the second horizontal cover portion 131.

The deionization electrode 200 may be disposed between the first case 120 and the second case 130. An accommodating space for the deionization electrode 200 may be formed between the first case 120 and the second case 130. At least a portion of a washing water flow path flowing from the inlet port 111 toward the outlet port 112 may be formed between the first case 120 and the second case 130.

According to an embodiment, the second case 130 may be disposed below the first case 120.

The first case 120 and the second case 130 may be coupled to each other. The first case 120 and the second case 130 may be coupled to each other to form an accommodating space for the deionization electrode 200 and at least a portion of a washing water flow path. According to an embodiment, the second case 130 may be coupled to a lower portion of the first case 120.

In contrast to the embodiment described above, in various embodiments, the first case 120 may include the first horizontal cover portion 121 but may not include the circumferential cover portion 122. In such an embodiment, the second case 130 may include the second horizontal cover portion 131 and a circumferential cover portion extending in the upward direction (+Z direction) from the second horizontal cover portion 131 to cover the circumferential surface of the deionization electrode 200.

According to an embodiment, the case 110 may include a cover case 140. The cover case 140 may cover the first case 120. The cover case 140 may cover the first case 120 in the first direction (Z-direction). For example, the cover case 140 may cover the first case 120 from above. The cover case 140 may form the upper surface of the case 110.

The cover case 140 may be coupled to the first case 120. For example, the cover case 140 may be coupled to the first case 120 by various methods, such as thermal fusion, screw fastening, or the like.

The receiving portion 115 may be formed between the first case 120 and the cover case 140. The first case 120 and the cover case 140 may be coupled to each other to form the receiving portion 115. The supply opening 141 connected to the receiving portion 115 may be formed in the cover case 140. The cap coupling portion 142 arranged to be coupled with the cap 119 for opening or closing the supply opening 141 may be provided on the cover case 140.

The filter 190 may be disposed in the receiving portion 115 formed between the first case 120 and the cover case 140. For example, the filter 190 may be seated on the upper surface of the first case 120 and may be covered by the cover case 140.

At least a portion of the inflow path 113 may be formed between the first case 120 and the cover case 140. The first case 120 and the cover case 140 may be coupled to each other to form at least a portion of the inflow path 113.

In an example, the inlet port 111 may be included in the cover case 140. In an example, the inlet port 111 may be formed on an upper surface of the cover case 140.

In an example, the outlet port 112 may be included in the cover case 140. In an example, the outlet port 112 may be formed on the upper surface of the cover case 140.

At least a portion of the supply flow path 116 may be formed between the first case 120 and the cover case 140. The first case 120 and the cover case 140 may be coupled to each other to form at least a portion of the supply flow path 116.

In an example, the tank connection port 117 may be included in the cover case 140. In an example, the tank connection port 117 may be formed on the upper surface of the cover case 140.

According to an embodiment, the case 110 may include a coupling case 150. The coupling case 150 may be configured to couple the first case 120 and the second case 130. The coupling case 150 may detachably couple the first case 120 and the second case 130.

A detailed description of the configuration for coupling the first case 120 and the second case 130 using the coupling case 150 will be described later.

The structures of the case 110 described above are merely one embodiment, and embodiments of the present disclosure are not limited thereto.

According to an embodiment, the water treatment device 100 may include a case seal 170. The case seal 170 may be disposed between the first case 120 and the second case 130. The case seal 170 may cover a gap between the first case 120 and the second case 130. The case seal 170 may reduce and/or prevent leakage from the interior of the case 110 by covering the gap between the first case 120 and the second case 130.

A detailed description of the case seal 170 will be described later.

The terminals 310, 320 and 330 may be coupled to the case 110.

For example, a first terminal 310, which will be described later, may be coupled to the first case 120. The first case 120 may include a first terminal coupling portion 121b configured to be coupled with the first terminal 310. In an example, the first terminal coupling portion 121b may be disposed on the first horizontal cover portion 121.

The first terminal 310 may penetrate the first terminal coupling portion 121b. In an example, the first terminal 310 may penetrate the first terminal coupling portion 121b in the first direction (Z-direction). The first terminal 310 may be coupled to the first case 120 by penetrating the first terminal coupling portion 121b and may contact the deionization electrode 200 (e.g., the first deionization electrode 210) disposed inside the case 110. In an example, the first terminal 310 may be movable in the first direction (Z-direction) relative to the first terminal coupling portion 121b.

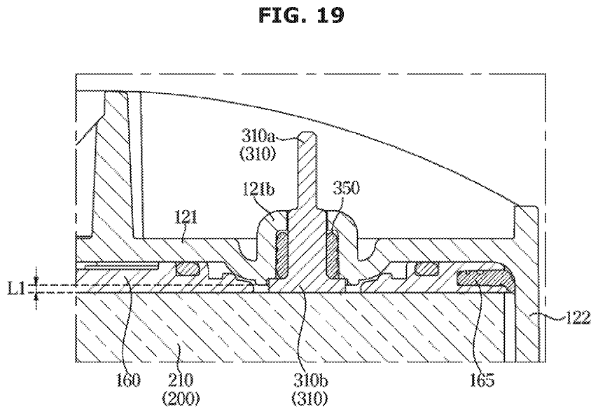

A first terminal seal 350 may be disposed between the first terminal 310 and the first terminal coupling portion 121b (see FIG. 19 etc.). The first terminal seal 350 may be disposed between an outer surface of the first terminal 310 and an inner surface of the first terminal coupling portion 121b. The first terminal seal 350 may cover a gap between the first terminal 310 and the first terminal coupling portion 121b, thereby preventing leakage from the interior of the case 110. The first terminal seal 350 may be configured to be elastically deformable. For example, the first terminal seal 350 may include a variety of elastic materials, such as rubber, elastic resin, and the like.

For example, a second terminal 320, which will be described later, may be coupled to the second case 130. The second case 130 may include a second terminal coupling portion 131b configured to be coupled with the second terminal 320. In an example, the second terminal coupling portion 131b may be disposed on the second horizontal cover portion 131.

The second terminal 320 may penetrate the second terminal coupling portion 131b. In an example, the second terminal 320 may penetrate the second terminal coupling portion 131b in the first direction (Z-direction). The second terminal 320 may be coupled to the second case 130 by penetrating the second terminal coupling portion 131b and may contact the deionization electrode 200 (e.g., the second deionization electrode 220) disposed inside the case 110. In an example, the second terminal 320 may be movable in the first direction (Z-direction) relative to the second terminal coupling portion 131b.

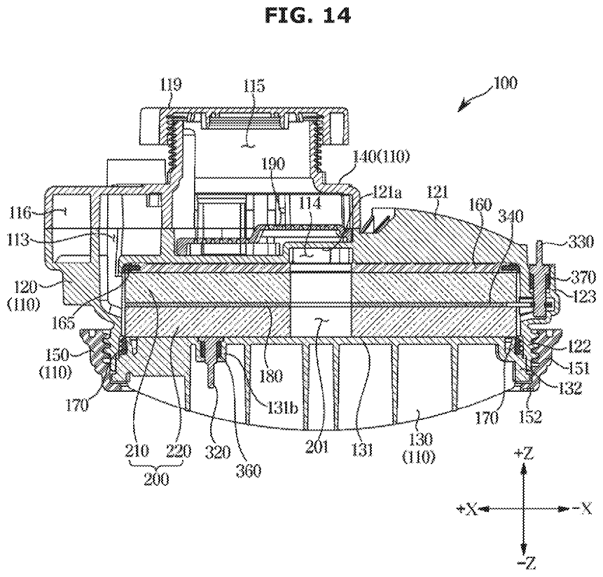

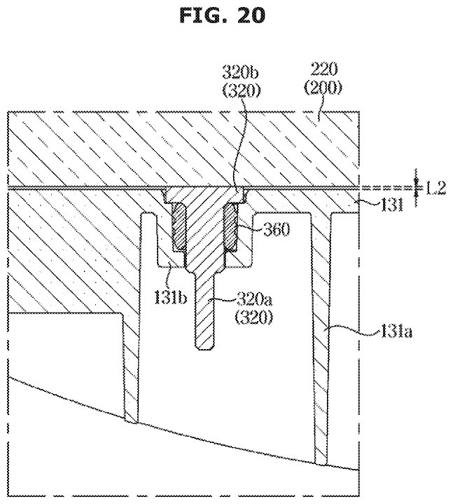

A second terminal seal 360 may be disposed between the second terminal 320 and the second terminal coupling portion 131b (see FIGS. 14 and 20 etc.). The second terminal seal 360 may be disposed between an outer surface of the second terminal 320 and an inner surface of the second terminal coupling portion 131b. The second terminal seal 360 may cover a gap between the second terminal 320 and the second terminal coupling portion 131b, thereby preventing leakage from the interior of the case 110. The second terminal seal 360 may be configured to be elastically deformable. For example, the second terminal seal 360 may include a variety of elastic materials, such as rubber, elastic resin, and the like.

For example, a pin terminal 330, which will be described later, may be coupled to the first case 120. The first case 120 may include the terminal accommodating portion 123 configured to accommodate at least a portion of the pin terminal 330. The pin terminal 330 may be coupled to the terminal accommodating portion 123.

The pin terminal 330 may be inserted into the terminal accommodating portion 123. In an example, the pin terminal 330 may be inserted into the terminal accommodating portion 123 in the first direction (Z-direction). The pin terminal 330 may be coupled to the first case 120 by being inserted into the terminal accommodating portion 123 and may be connected to a contact terminal 340 disposed inside the case 110.

A pin terminal seal 370 may be disposed between the pin terminal 330 and the terminal accommodating portion 123 (see FIG. 14 etc.). The pin terminal seal 370 may be disposed between an outer surface of the pin terminal 330 and an inner surface of the terminal accommodating portion 123. The pin terminal seal 370 may contact the outer surface of the pin terminal 330 and the inner surface of the terminal accommodating portion 123. The pin terminal seal 370 may cover a gap between the pin terminal 330 and the terminal accommodating portion 123, thereby preventing leakage from the interior of the case 110. The pin terminal seal 370 may be configured to be elastically deformable. For example, the pin terminal seal 370 may include a variety of elastic materials, such as rubber, elastic resin, and the like.

According to an embodiment, the water treatment device 100 may include a flow path partition 160. The flow path partition 160 may be configured to partition the inflow path 113 and the outflow path 114. The flow path partition 160 may prevent raw water and soft water from mixing.

The flow path partition 160 may be disposed between the deionization electrode 200 and the first case 120. The flow path partition 160 may be arranged in the first direction (Z-direction) with the deionization electrode 200 and the first horizontal cover portion 121 of the first case 120. For example, the flow path partition 160 may be disposed below (−Z direction) the first horizontal cover portion 121. For example, the flow path partition 160 may be disposed above (+Z direction) the deionization electrode 200.

The flow path partition 160 may be in contact with the first case 120. For example, the flow path partition 160 may be in contact with an inner surface of the first horizontal cover portion 121.

The flow path partition 160 may be in contact with the deionization electrode 200. For example, the flow path partition 160 may be in contact with one surface of the first deionization electrode 210 extending in the horizontal direction (e.g., an upper surface). For example, the flow path partition 160 may be in contact with one flat surface (e.g., an upper surface) of the first deionization electrode 210.

In an example, the flow path partition 160 may have a substantially flat disk shape, but the shape thereof is not limited thereto.

The flow path partition 160 may form at least a portion of the outflow path 114 between the flow path partition 160 and the first case 120. The flow path partition 160 may face the inner surface of the first horizontal cover portion 121, and at least a portion of the outflow path 114 may be formed between the flow path partition 160 and the first horizontal cover portion 121. The outflow path 114 may be disposed above (+Z direction) the flow path partition 160. For example, the first horizontal cover portion 121 may include an outflow path groove 121a having a shape recessed in the upward direction (+Z direction) from the inner surface. The outflow path 114 may be formed between the flow path partition 160 and the outflow path groove 121a. The outflow path groove 121a may be connected to the outlet port 112.

The flow path partition 160 may include a flow path partition hole 161 configured to allow water to pass therethrough. The flow path partition hole 161 may be positioned correspondingly to the hollow 201 of the deionization electrode 200. The flow path partition hole 161 may abut the hollow 201 of the deionization electrode 200. A portion of a flow path through which water flows may be formed in response to the hollow 201 of the deionization electrode 200 and the flow path partition hole 161 being connected to each other. The flow path partition hole 161 may be configured to allow soft water treated by passing through the deionization electrode 200 to pass therethrough.

The first terminal 310 may penetrate the flow path partition 160. The first terminal 310 may penetrate the first case 120 and the flow path partition 160 in the first direction (Z-direction) to abut the first deionization electrode 210.

According to an embodiment, the water treatment device 100 may include a flow path partition seal 165. The flow path partition seal 165 may be disposed between the flow path partition 160 and the first case 120. The flow path partition seal 165 may be disposed between a circumference of the flow path partition 160 and an inner wall of the circumferential cover portion 122 of the first case 120. In an example, the flow path partition seal 165 may be coupled to the circumference of the flow path partition 160. The flow path partition seal 165 may cover a gap between the flow path partition 160 and the circumferential cover portion 122 to partition the inflow path 113 and the outflow path 114.

In an example, the flow path partition seal 165 may have a substantially ring shape.

The flow path partition seal 165 may be configured to be elastically deformable. For example, the flow path partition seal 165 may include a variety of elastic materials, such as rubber, elastic resin, and the like.

According to an embodiment, the water treatment device 100 may include an electrode partition 180. The electrode partition 180 may be disposed between the first deionization electrode 210 and the second deionization electrode 220. The first deionization electrode 210, the electrode partition 180, and the second deionization electrode 220 may be sequentially disposed in the first direction (Z-direction). The electrode partition 180 may be in contact with the first deionization electrode 210 and the second deionization electrode 220, respectively. The electrode partition 180 may be in contact with a lower surface of the first deionization electrode 210 and may be in contact with an upper surface of the second deionization electrode 220.

The electrode partition 180 may electrically insulate the first deionization electrode 210 and the second deionization electrode 220. The electrode partition 180 may include a variety of insulating materials.

In an example, the electrode partition 180 may have a substantially flat disk shape, but the shape thereof is not limited thereto.

The electrode partition 180 may include an electrode partition hole 181 configured to allow water to pass therethrough. The electrode partition hole 181 may be connected to the hollow 201 of the deionization electrode 200. The electrode partition hole 181 may be configured to allow soft water treated by passing through the deionization electrode 200 to pass therethrough.

The electrode partition 180 may include a terminal groove 182 in which a portion of the contact terminal 340, which will be described later, provided to be disposed. A portion of the contact terminal 340 may be inserted into the terminal groove 182 of the electrode partition 180. For example, a portion of the contact terminal 340 may be inserted into the terminal groove 182 of the electrode partition 180 in the second direction (X-direction). A portion of the contact terminal 340 may penetrate the terminal groove 182 of the electrode partition 180. For example, a portion of the contact terminal 340 may penetrate the terminal groove 182 of the electrode partition 180 in the first direction (Z-direction). The terminal groove 182 may have a shape recessed inwardly from a rim of the electrode partition 180.

Referring to FIG. 9, the process by which water is treated as it passes through the water treatment device 100 according to the structure described above will be described.

Referring to FIG. 9, raw water from a water source may be introduced into the case 110 through the inlet port 111. The raw water introduced into the case 110 may pass through the receiving portion 115. The raw water introduced into the case 110 may flow through the filter 190 and toward the deionization electrode 200 along the inflow path 113. The raw water flowing along the inflow path 113 may be introduced into the deionization electrode 200 through the circumferential surface of the deionization electrode 200, be softened while passing through the deionization electrode 200 in an inward direction, and then be discharged through the hollow 201. The soft water discharged through the hollow 201 may flow to the outflow path 114 between the first case 120 and the flow path partition 160. For example, soft water passing through the first deionization electrode 210 may flow sequentially through the hollow 201 of the first deionization electrode 210 and the flow path partition hole 161 into the outflow path 114, and the soft water passing through the second deionization electrode 220 may flow sequentially through the hollow 201 of the second deionization electrode 220, the electrode partition hole 181, the hollow 201 of the first deionization electrode 210, and the flow path partition hole 161 into the outflow path 114. The soft water introduced into the outflow path 114 may flow along the outflow path 114 to the outlet port 112, and may be discharged to the outside of the case 110 through the outlet port 112.

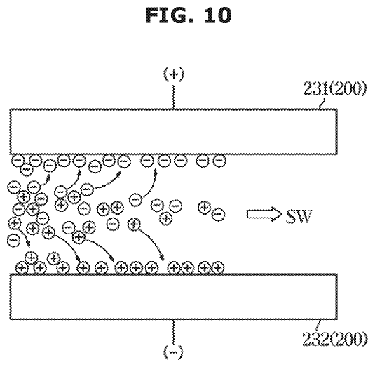

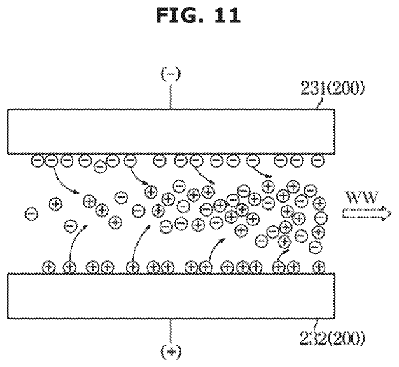

FIG. 10 is a schematic view illustrating a process of softening water by the water treatment device of the dishwasher according to an embodiment of the present disclosure. FIG. 11 is a schematic view illustrating a process of removing scale from the water treatment device of the dishwasher according to an embodiment of the present disclosure.

With reference to FIGS. 10 and 11, a process of softening water by the deionization electrode 200 included in the water treatment device 100 according to an embodiment of the present disclosure and an operation of regenerating the deionization electrode 200 will be described.

According to an embodiment, the deionization electrode 200 may include a plurality of electrode layers 231 and 232. In an example, the plurality of electrode layers 231 and 232 may be stacked in the first direction (Z-direction). When a voltage is applied to the deionization electrode 200, an electric field may be generated between a pair of adjacent electrode layers (e.g., a first electrode layer 231 and a second electrode layer 232) of the plurality of electrode layers 231 and 232.

Referring to FIG. 10, as a first voltage (adsorption voltage) for adsorbing ionic substances from water is applied to the deionization electrode 200, an electric field may be generated between the first electrode layer 231 and the second electrode layer 232. In an example, one side of the first electrode layer 231 may act as an anode, and one side of the second electrode layer 232 may act as a cathode. In this case, when water is moved between the first electrode layer 231 and the second electrode layer 232, which are spaced apart from each other, ionic substances contained in the water may be moved to the first electrode layer 231 and the second electrode layer 232 due to an electric attraction force by the electric field. For example, ionic substances with a negative charge may migrate to the first electrode layer 231 and be adsorbed, and ionic substances with a positive charge may migrate to the second electrode layer 232 and be adsorbed. Through such a process, the water passing through the deionization electrode 200 may be discharged as soft water (SW) that contains no ionic substances or a very low amount of ionic substances.

As ionic substances continue to accumulate on the first electrode layer 231 and the second electrode layer 232 over a continuous water treatment process, the electric field formed between the first electrode layer 231 and the second electrode layer 232 may weaken, thereby reducing the ion adsorption capability of the deionization electrode 200. To restore the ion adsorption capability of the deionization electrode 200, a regeneration process or a scale removal process may be performed.

As described above, when a regeneration process of the water treatment device 100 is to be performed, a regeneration material for removing scale from the deionization electrode 200 may be input into the receiving portion 115. For example, a user may access the cap 119 through the interior of the tub 12, release the cap 119 from the cap coupling portion 142 to open the supply opening 141, and then input the regeneration material into the receiving portion 115 through the supply opening 141. For example, the regeneration material may include an acidic solution for removing scale from the deionization electrode 200. For example, the acidic solution may include a citric acid solution.

Referring to FIG. 11, to restore the ion adsorption capability of the deionization electrode 200, a second voltage (regeneration voltage) opposite to the first voltage applied for the water treatment process may be applied to the deionization electrode 200. When the second voltage is applied to the deionization electrode 200, an electric field in a direction opposite to that during the water treatment process may be generated between the first electrode layer 231 and the second electrode layer 232. In an example, one side of the first electrode layer 231 may act as a negative electrode, and one side of the second electrode layer 232 may act as a positive electrode. Accordingly, the ionic substances attached to the first electrode layer 231 and the second electrode layer 232 may be separated from the first electrode layer 231 and the second electrode layer 232. Through such a process, the ionic substances removed from the deionization electrode 200 may be discharged as wastewater (WW) along with water.

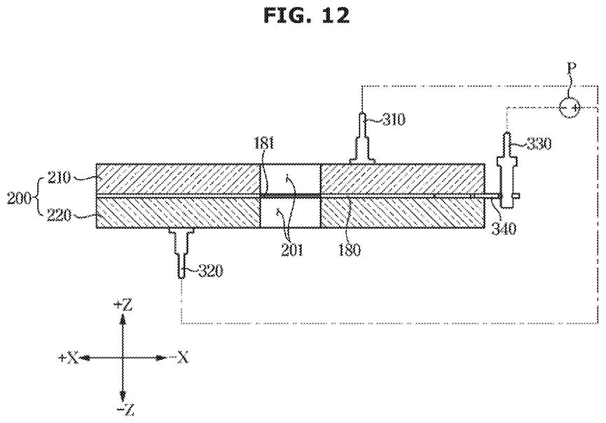

FIG. 12 is a view illustrating various configurations, such as a deionization electrode and a plurality of terminals included in the water treatment device of the dishwasher according to an embodiment of the present disclosure.

Referring to FIG. 12, the water treatment device 100 of the dishwasher 1 according to an embodiment of the present disclosure may include the plurality of deionization electrodes 200. The water treatment device 100 may include the first deionization electrode 210 and the second deionization electrode 220. In an example, the first deionization electrode 210 and the second deionization electrode 220 may be arranged in the first direction (Z-direction) relative to each other.

The plurality of deionization electrodes 200 may be electrically insulated from each other. For example, the first deionization electrode 210 and the second deionization electrode 220 may be electrically insulated from each other by the electrode partition 180. A voltage may be applied to each of the first deionization electrode 210 and the second deionization electrode 220. The first deionization electrode 210 and the second deionization electrode 220 may be included in separate electric circuits.

Each of the plurality of deionization electrodes 200 may be electrically connected to a power source P via the terminals 310, 320, 330 and 340. Each of the plurality of deionization electrodes 200 may receive a voltage from the power source P via the terminals 310, 320, 330 and 340. The power source P may be a power source disposed outside the case 110.

The water treatment device 100 may include the first terminal 310. The first terminal 310 may be electrically connected to the first deionization electrode 210. The first terminal 310 may be configured to electrically connect the first deionization electrode 210 to the power source P. The first terminal 310 may be connected to one side of the first deionization electrode 210. For example, the first terminal 310 may contact the first deionization electrode 210 in the first direction (Z-direction). For example, the first terminal 310 may contact one side of the first deionization electrode 210 opposite to the second deionization electrode 220. For example, the first terminal 310 may contact one side of the first deionization electrode 210 extending in the horizontal direction. For example, the first terminal 310 may contact one flat surface of the first deionization electrode 210. For example, the first terminal 310 may contact an upper surface of the first deionization electrode 210.

In an example, the first terminal 310 may penetrate the first case 120 and the flow path partition 160 to contact the first deionization electrode 210. In an example, the first terminal 310 may penetrate the first horizontal cover portion 121 and the flow path partition 160 to contact the first deionization electrode 210.

The water treatment device 100 may include the second terminal 320. The second terminal 320 may be electrically connected to the second deionization electrode 220. The second terminal 320 may be configured to electrically connect the second deionization electrode 220 to the power source P. The second terminal 320 may be connected to one side of the second deionization electrode 220. For example, the second terminal 320 may contact the second deionization electrode 220 in the first direction (Z-direction). For example, the second terminal 320 may contact one side of the second deionization electrode 220 opposite to the first deionization electrode 210. For example, the second terminal 320 may contact one side of the second deionization electrode 220 extending in the horizontal direction. For example, the second terminal 320 may contact one flat surface of the second deionization electrode 220. For example, the second terminal 320 may contact a lower surface of the second deionization electrode 220.

In an example, the second terminal 320 may penetrate the second case 130 to contact the second deionization electrode 220. In an example, the second terminal 320 may penetrate the second horizontal cover portion 131 to contact the second deionization electrode 220.

The water treatment device 100 may include the pin terminal 330 and the contact terminal 340. The pin terminal 330 and the contact terminal 340 may be electrically connected to each other. The pin terminal 330 may be electrically connected to the power source P. The pin terminal 330 may electrically connect the contact terminal 340 to the power source P. The pin terminal 330 and the contact terminal 340 may be electrically connected to the deionization electrode 200. The pin terminal 330 and the contact terminal 340 may electrically connect the deionization electrode 200 to the power source P.

The pin terminal 330 and the contact terminal 340 may be configured to electrically connect the first deionization electrode 210 to the power source P. The contact terminal 340 may be electrically connected to the first deionization electrode 210. The contact terminal 340 may contact the first deionization electrode 210. For example, the contact terminal 340 may contact the first deionization electrode 210 in the first direction (Z-direction). For example, the contact terminal 340 may contact one side of the first deionization electrode 210 adjacent to the second deionization electrode 220. For example, the contact terminal 340 may contact one side of the first deionization electrode 210 extending in the horizontal direction. For example, the contact terminal 340 may contact one flat surface of the first deionization electrode 210. For example, the contact terminal 340 may contact a lower surface of the first deionization electrode 210. A portion of the lower surface of the first deionization electrode 210 may contact the electrode partition 180, and another portion may contact the contact terminal 340.

The pin terminal 330 and the contact terminal 340 may be configured to electrically connect the second deionization electrode 220 to the power source P. The contact terminal 340 may be electrically connected to the second deionization electrode 220. The contact terminal 340 may contact the second deionization electrode 220. For example, the contact terminal 340 may contact the second deionization electrode 220 in the first direction (Z-direction). For example, the contact terminal 340 may contact one side of the second deionization electrode 220 adjacent to the first deionization electrode 210. For example, the contact terminal 340 may contact one side of the second deionization electrode 220 extending in the horizontal direction. For example, the contact terminal 340 may contact one flat surface of the second deionization electrode 220. For example, the contact terminal 340 may contact the upper surface of the second deionization electrode 220. A portion of the upper surface of the second deionization electrode 220 may contact the electrode partition 180, and another portion may contact the contact terminal 340.

The contact terminal 340 may be disposed between the first deionization electrode 210 and the second deionization electrode 220. The contact terminal 340 may be referred to by a term such as ‘intermediate terminal’.

With such a structure, the power source P, the first terminal 310, the first deionization electrode 210, the contact terminal 340, and the pin terminal 330 may constitute one electric circuit, and the power source P, the second terminal 320, the second deionization electrode 220, the contact terminal 340, and the pin terminal 330 may constitute another electric circuit.

In an example, the first terminal 310 and the second terminal 320 may connect the deionization electrode 200 to a positive electrode of the power source P, and the contact terminal 340 and the pin terminal 330 may connect the deionization electrode 200 to a negative electrode of the power source P, but embodiments of the present disclosure are not limited thereto.

As such, by applying a voltage to the first deionization electrode 210 using the first terminal 310, the pin terminal 330, and the contact terminal 340, and applying a separate voltage to the second deionization electrode 220 using the second terminal 320, the pin terminal 330, and the contact terminal 340, each of the first deionization electrode 210 and the second deionization electrode 220 may provide sufficient deionization performance even when a relatively low voltage is applied to each of the first deionization electrode 210 and the second deionization electrode 220.

In an embodiment where the deionization electrode 200 is not divided into the first deionization electrode 210 and the second deionization electrode 220, applying a voltage between the upper and lower surfaces of the deionization electrode 200 using only the first terminal 310 and the second terminal 320 may result in poor deionization performance, or may require applying a relatively high voltage to achieve sufficient deionization performance.

By using a pair of terminals that penetrate the deionization electrode 200 in the first direction (Z) from the upper surface to the lower surface, and by contacting the terminals throughout the plurality of electrode layers included in the deionization electrode 200, it is possible to achieve sufficient deionization performance even under a relatively low voltage. However, in such an embodiment, the deionization electrode 200 may be more likely to be damaged by the terminals penetrating thererthough. In particular, each of the plurality of electrode layers included in the deionization electrode 200 may include a brittle material, such as a porous carbon electrode, which may be easily damaged when the terminals penetrate therethrough.

In an embodiment of the present disclosure, the deionization electrode 200 may be electrically connected to the terminals by bringing the terminals into contact with the outer surface of the deionization electrode 200 without penetrating the deionization electrode 200. By applying voltages to each of the first deionization electrode 210 and the second deionization electrode 220 to perform the water treatment process, sufficient performance may be achieved even with relatively low applied voltages, thereby improving the deionization performance.

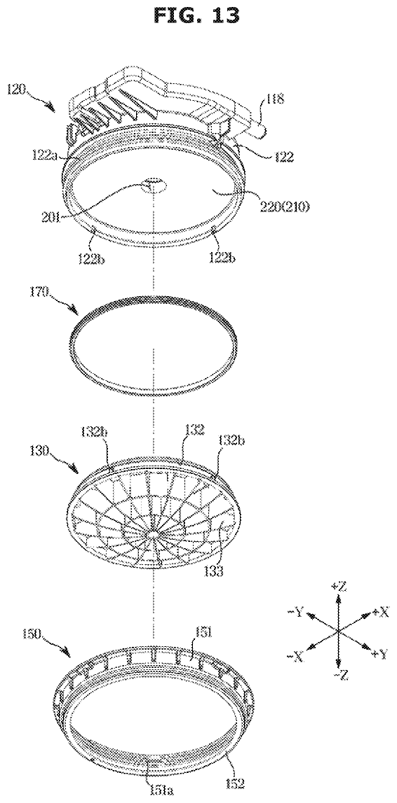

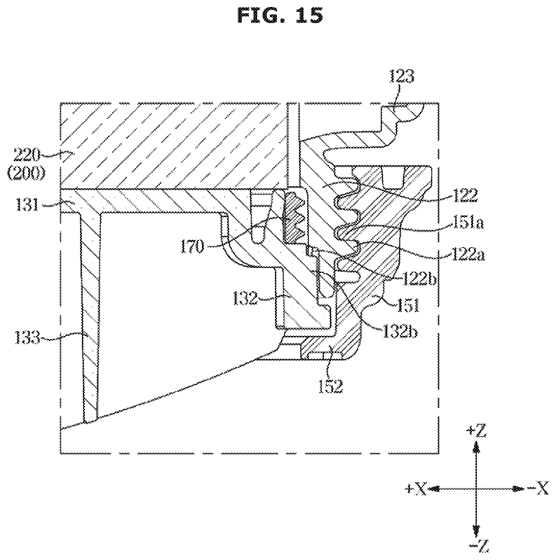

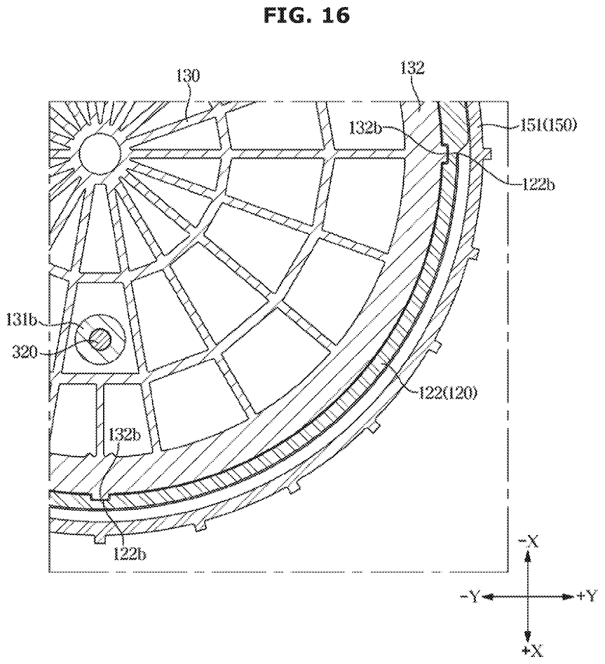

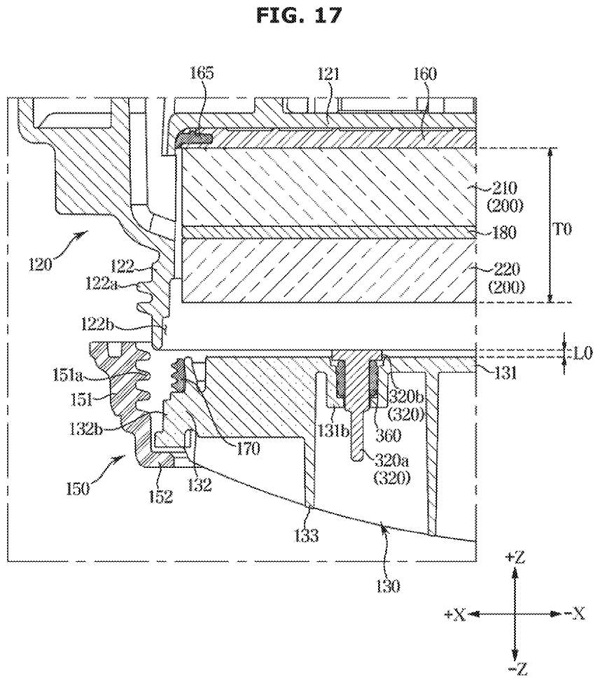

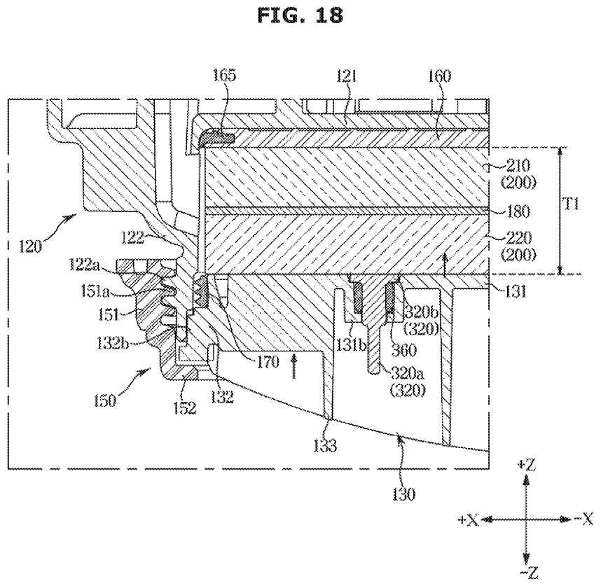

FIG. 13 is an exploded perspective view illustrating some configurations of the water treatment device of the dishwasher according to an embodiment of the present disclosure. FIG. 14 is a cross-sectional view of the water treatment device of the dishwasher according to an embodiment of the present disclosure. FIG. 15 is an enlarged cross-sectional view illustrating a part of the water treatment device of the dishwasher according to an embodiment of the present disclosure. FIG. 16 is an enlarged cross-sectional view illustrating a part of a first case, a second case, and a coupling case included in the water treatment device of the dishwasher according to an embodiment of the present disclosure. FIG. 17 is an enlarged cross-sectional view illustrating a part of the water treatment device of the dishwasher according to an embodiment of the present disclosure, showing a state in which the first case and the second case are separated. FIG. 18 is an enlarged cross-sectional view illustrating a part of the water treatment device of the dishwasher according to an embodiment of the present disclosure, showing a state in which the first case and the second case are coupled.

Referring to FIGS. 13 to 18, the water treatment device 100 of the dishwasher 1 according to an embodiment of the present disclosure may include the first case 120, the second case 130, and the coupling case 150.

The first case 120 and the second case 130, when coupled to each other, may form a space for accommodating the deionization electrode 200 therein. When the first case 120 and the second case 130 are coupled to each other, the first case 120 may cover a portion of the deionization electrode 200, and the second case 130 may cover other portions of the deionization electrode 200. A space in which the deionization electrode 200 is accommodated may be formed between the first case 120 and the second case 130, and the size (e.g., thickness, volume, etc.) of the space may vary depending on the size or relative positional relationship of each of the first case 120 and the second case 130. For example, depending on a distance in the first direction (Z-direction) between the first horizontal cover portion 121 of the first case 120 and the second horizontal cover portion 131 of the second case 130, a length in the first direction (Z-direction) of the space formed between the first case 120 and the second case 130 may vary.

In a case where the second case 130 is designed to be fixed at a constant position relative to the first case 120 when the first and second cases 120 and 130 are coupled together, it may be difficult to adjust the size of the space formed between the first case 120 and the second case 130. In such a case, when various components of the water treatment device 100, such as, for example, the first case 120, the second case 130, and the deionization electrode 200, are not accurately formed to the designed sizes, problems may arise, such as the deionization electrode 200 not being sufficiently contact the first terminal 310 coupled to the first case 120 or the second terminal 320 coupled to the second case 130, or the deionization electrode 200 being excessively pressed by the first terminal 310 or the second terminal 320 and being damaged. In other words, under these examples, it may be difficult to adjust the size of the space between the first case 120 and the second case 130, which may potentially prevent the deionization electrode 200 from reliably contacting the first terminal 310 or the second terminal 320.

According to an embodiment of the present disclosure, the second case 130 may be couplable to the first case 120 and detachable from the first case 120. The second case 130 may be configured to be movable relative to the first case 120 when coupled to or detached from the first case 120. For example, the second case 130 may be movable in one direction relative to the first case 120. For example, the second case 130 may movable in a direction toward or away from the first case 120. For example, the second case 130 may be movable in a linear reciprocating direction relative to the first case 120. For example, the second case 130 may be movable in the first direction (Z-direction) relative to the first case 120.

As such, as the second case 130 is movably coupled to the first case 120 when the second case 130 is coupled to or detached from the first case 120, the size of the space formed between the first case 120 and the second case 130 may be adjusted.

For example, when the second case 130 in moved toward the first case 120 in the first direction (Z-direction) (e.g., upward (+Z direction) movement), the size (e.g., the length in the first direction (Z-direction)) of the space formed between the first case 120 and the second case 130 may be reduced. In an example, a distance (a distance in the first direction (Z-direction)) between the first horizontal cover portion 121 and the second horizontal cover portion 131 may be decreased. As the second case 130 moves toward the first case 120, the deionization electrode 200 disposed between the first case 120 and the second case 130 may be depressed and compressed.

For example, when the second case 130 is moved away from the first case 120 in the first direction (Z-direction) (e.g., downward (−Z direction) movement), the size (e.g., the length in the first direction (Z-direction)) of the space formed between the first case 120 and the second case 130 may increase. In an example, the distance (the distance in the first direction (Z-direction)) between the first horizontal cover portion 121 and the second horizontal cover portion 131 may be increased. As the second case 130 moves in a direction away from the first case 120, the degree to which the deionization electrode 200 disposed between the first case 120 and the second case 130 is depressed and compressed may decrease, and the deionization electrode 200 may expand, for example.

As such, as the size of the space formed between the first case 120 and the second case 130 is adjustable, the degree to which the deionization electrode 200 is depressed and compressed by the first case 120 and the second case 130 may be adjustable. Thus, the degree to which the deionization electrode 200 contacts the first terminal 310 coupled to the first case 120 and/or the second terminal 320 coupled to the second case 130 may be adjustable. According to an embodiment, as the direction in which the second case 130 is movable relative to the first case 120 (e.g., the first direction (Z-direction)) and the direction in which the first terminal 310 and/or the second terminal 320 contacts the deionization electrode 200 (e.g., the first direction (Z-direction)) are parallel to each other, the degree to which the deionization electrode 200 contacts the first terminal 310 and/or the second terminal 320 while moving the second case 130 relative to the first case 120 may be more efficiently adjusted.

According to an embodiment, the coupling case 150 may be configured to couple the first case 120 and the second case 130. Since the second case 130 may be movable relative to the first case 120 and not fixed, the coupling case 150 may support the second case 130 such that the second case 130 is fixed at a certain position relative to the first case 120.

According to an embodiment, the coupling case 150 may move the second case 130 relative to the first case 120 when coupling the second case 130 to the first case 120. The coupling case 150 may be configured to move the second case 130 toward the first case 120 when coupling the second case 130 to the first case 120. The coupling case 150 may movably couple the second case 130 to the first case 120. The coupling case 150 may be configured to press the second case 130 toward the first case 120 when coupling the first case 120 and the second case 130. The relative position of the second case 130 relative to the first case 120 may vary depending on the degree to which the coupling case 150 presses against the second case 130. For example, the coupling case 150 may be configured to press the second case 130 in the first direction (Z-direction) (e.g., upward (+Z direction)) when coupling the first case 120 and the second case 130, and the position of the second case 130 in the first direction (Z-direction) relative to the first case 120 may vary depending on the degree to which the coupling case 150 presses against the second case 130. The size of the space (e.g., the length in the first direction (Z-direction)) between the first case 120 and the second case 130 may vary depending on the degree to which the coupling case 150 presses against the second case 130. For example, the distance in the first direction (Z-direction) between the first horizontal cover portion 121 and the second horizontal cover portion 131 may vary depending on the degree to which the coupling case 150 presses against the second case 130. The degree to which the deionization electrode 200 is depressed and compressed by the first case 120 and the second case 130 may be adjusted depending on the degree to which the coupling case 150 presses against the second case 130. The degree to which the deionization electrode 200 contacts the first terminal 310 and/or the second terminal 320 may be adjusted depending on the degree to which the coupling case 150 presses against the second case 130.

According to an embodiment, the coupling case 150 may be movable relative to the first case 120 when coupling the first case 120 and the second case 130. By coupling the first case 120 and the second case 130 while the coupling case 150 is movable relative to the first case 120, the degree to which the first case 120 and the second case 130 are coupled to each other may be easily adjusted, and the relative position of the second case 130 with respect to the first case 120 may be easily adjusted. For example, the coupling case 150 may move relative to the first case 120 and support the second case 130 to facilitate adjusting the relative position of the second case 130 relative to the first case 120.

According to an embodiment, the coupling case 150 may be coupled to the first case 120. The coupling case 150 may include the case coupling portion 151 configured to be coupled to the first case 120. For example, the case coupling portion 151 may be coupled to the circumferential cover portion 122 of the first case 120. For example, the case coupling portion 151 may cover the circumferential cover portion 122 from the outside. For example, the case coupling portion 151 may abut an outer surface of the circumferential cover portion 122. The case coupling portion 151 may form a circumferential surface of the coupling case 150.

The case coupling portion 151 may be movably coupled to the first case 120. For example, the case coupling portion 151 may be movably coupled to the circumferential cover portion 122.

According to an embodiment, the first case 120 may include a first thread 122a. For example, the first thread 122a may be formed on the outer surface of the circumferential cover portion 122 of the first case 120. For example, the first thread 122a may extend in a helical shape along the circumference of the circumferential cover portion 122. The coupling case 150 may include a second thread 151a configured to engage with the first thread 122a. For example, the second thread 151a may be formed on an inner surface of the case coupling portion 151 of the coupling case 150. For example, the second thread 151a may extend in a helical form along a circumference of the case coupling portion 151. The first case 120 and the coupling case 150 may be configured to be coupled by the engagement of the first thread 122a and the second thread 151a with each other. For example, the case coupling portion 151 may be coupled to the circumferential cover portion 122 as the first thread 122a and the second thread 151a engage with each other. The coupling case 150 may be movable relative to the first case 120 by adjusting the degree to which the first thread 122a and the second thread 151a engage with each other. For example, as the degree of engagement between the first thread 122a and the second thread 151a increases, the coupling case 150 may move upwardly (+Z direction) relative to the first case 120. For example, as the degree of engagement between the first thread 122a and the second thread 151a decreases, the coupling case 150 may move downwardly (−Z direction) relative to the first case 120.

The coupling case 150 may be rotatably coupled to the first case 120. For example, the coupling case 150 may be rotatable relative to the first case 120 about a rotation axis extending in the first direction (Z-direction). The degree to which the first thread 122a and the second thread 151a engage with each other may be adjustable as the coupling case 150 is rotated relative to the first case 120. The coupling case 150 may move in the first direction (Z-direction) relative to the first case 120 as it is rotated relative to the first case 120 about the rotation axis extending in the first direction (Z-direction).

According to an embodiment, the coupling case 150 may support the second case 130. For example, the coupling case 150 may support the second case 130 on a side opposite to the first case 120. For example, the coupling case 150 may abut the second case 130 on the side opposite to the first case 120. For example, the coupling case 150 may support a lower end of the second case 130.

As the coupling case 150 supports the second case 130, the relative position of the second case 130 with respect to the first case 120 may vary depending on the relative position of the coupling case 150 with respect to the first case 120. For example, as the degree of coupling between the first case 120 and the coupling case 150 (e.g., the degree of engagement between the first thread 122a of the first case 120 and the thread 151a of the coupling case 150) increases, the coupling case 150 may press the second case 130 toward the first case 120. In this case, for example, the second case 130 may move closer to the first case 120 in the first direction (Z-direction). For example, as the degree of coupling between the first case 120 and the coupling case 150 (e.g., the degree of engagement between the first thread 122a of the first case 120 and the thread 151a of the coupling case 150) decreases, the second case 130 may move away from the first case 120 in the first direction (Z-direction).

According to an embodiment, the coupling case 150 may include a support 152. The support 152 may be configured to support the second case 130. For example, the support 152 may be configured to support the second case 130 on a side opposite to the deionization electrode 200. For example, the support 152 may be configured to support the second case 130 on a side opposite to the first case 120. For example, the support 152 may be configured to support one side of the second case 130 opposite to the deionization electrode 200. For example, the support 152 may be configured to support the second case 130 in the first direction (Z-direction). The support 152 may abut one side of the second case 130. For example, the support 152 may abut a lower side of the second case 130. For example, the support 152 may abut a lower end of the circumferential wall 132.

For example, the support 152 may extend from a portion of the coupling case 150 that covers the first case 120. For example, the support 152 may extend from the case coupling portion 151. For example, the support 152 may extend in a direction different from an extending direction of the case coupling portion 151. For example, the support 152 may extend inwardly from the case coupling portion 151. For example, the support 152 may extend inwardly from a lower end of the case coupling portion 151 to abut the second case 130.

As the coupling case 150 moves relative to the first case 120, the degree to which the support 152 presses against the second case 130 may vary.

As such, the degree of coupling and the relative position between the first case 120 and the second case 130 may be adjusted using the coupling case 150, and the degree to which the deionization electrode 200 is depressed and/or compressed between the first case 120 and the second case 130 may be adjusted. As a result, the deionization electrode 200 may be reliably contacted by the terminals (e.g., the first terminal 310 and the second terminal 320) mounted on the first case 120 and the second case 130.

In addition, the coupling case 150 may be utilized to couple the first case 120 and the second case 130, thereby eliminating the need for separate screwing or thermal fusion processes between components during the assembly of the case 110. As a result, the steps of assembling the case 110 or disassembling the case 110 may be simplified. Further, the manufacturing cost of the case 110 may be reduced. Furthermore, compared to examples in which the case 110 is assembled through processes such as separate screwing or thermal fusion, the aesthetic quality of the water treatment device 100 may be improved in the embodiment of the present disclosure using the coupling case 150.

According to an embodiment, the coupling case 150 may have a substantially ring shape, but its shape is not limited thereto.

According to an embodiment, the second case 130 may be coupled to the first case 120 so as to be movable in the first direction (Z-direction), but may be engaged with the first case 120 to prevent movement in a direction different from the first direction (Z-direction) relative to the first case 120. For example, by being engaged with the first case 120, the second case 130 may be prevented from moving in a direction perpendicular to the first direction (Z-direction) relative to the first case 120. For example, by being engaged with the first case 120, the second case 130 may be prevented from rotating about the rotation axis extending in the first direction (Z-direction).

As described above, the second terminal 320 may be coupled to the second case 130. The second terminal 320 may contact the deionization electrode 200 in the first direction (Z-direction) while penetrating the second case 130. When the second case 130 is not restricted from moving in a direction different from the first direction (Z-direction) relative to the first case 120, for example, during the process of coupling the second case 130 to the first case 120 using the coupling case 150, friction may occur between the second terminal 320 coupled to the second case 130 and the deionization electrode 200 as the second case 130 rotates about the rotation axis extending in the first direction (Z-direction). In the embodiment of the present disclosure, as the second case 130 is prevented from moving in a direction different from the first direction (Z-direction) relative to the first case 120, friction may not be generated between the second terminal 320 and the deionization electrode 200, which may reduce and/or prevent damage to the deionization electrode 200.

Referring to FIG. 16, and the like, the first case 120 may include a case groove 122b. The case groove 122b may be recessed from an inner surface of the first case 120 that covers the second case 130. For example, the case groove 122b may be recessed from an inner surface of the circumferential cover portion 122. For example, the case groove 122b may be recessed outwardly from the inner surface of the circumferential cover portion 122. The second case 130 may include a case protrusion 132b. The case protrusion 132b may protrude from the outer surface of the second case 130. The case protrusion 132b may be inserted into the case groove 122b. For example, the case protrusion 132b may protrude from the outer surface of the circumferential wall 132. For example, the case protrusion 132b may protrude outwardly from the outer surface of the circumferential wall 132.

As the case protrusion 132b is inserted into the case groove 122b, the first case 120 and the second case 130 may be engaged with each other such that the second case 130 is restricted from moving in a direction different from the first direction (Z-direction) relative to the first case 120.

In an example, the case groove 122b and the case protrusion 132b may extend in the direction in which the second case 132 is movable relative to the first case 120 (e.g., the first direction (Z-direction)).

In an example, a plurality of case grooves 122b may be provided. The plurality of case grooves 122b may be arranged along a circumferential direction of the inner surface of the first case 120. The plurality of case grooves 122b may be arranged along a circumferential direction of the inner surface of the circumferential cover portion 122.

In an example, a plurality of case protrusions 132b may be provided. The plurality of case protrusions 132b may be arranged along a circumferential direction of the outer surface of the second case 130. The plurality of case protrusions 132b may be arranged along a circumferential direction of the outer surface of the circumferential wall 132.

According to an embodiment, the water treatment device 100 may include the case seal 170. The case seal 170 may be disposed between the first case 120 and the second case 130. For example, the case seal 170 may be disposed between the circumferential cover portion 122 of the first case 120 and the circumferential wall 132 of the second case 130. For example, the case seal 170 may be disposed between the inner surface of the circumferential cover portion 122 of the first case 120 and the outer surface of the circumferential wall 132 of the second case 130. The case seal 170 may be configured to cover the gap between the first case 120 and the second case 130 to prevent leakage of washing water from inside the case 110.

For example, the case seal 170 may contact the inner surface of the circumferential cover portion 122. For example, the case seal 170 may contact the outer surface of the circumferential wall 132.

The case seal 170 may be configured to be elastically deformable. For example, the case seal 170 may include a variety of elastic materials, such as rubber, elastic resin, and the like.

According to an embodiment, the case seal 170 may contact the first case 120 and the second case 130 in a direction (e.g., the horizontal direction) different from the direction in which the second case 130 is movable relative to the first case 120 (e.g., the first direction (Z-direction)). As a result, even if the degree of coupling or the relative position between the first case 120 and the second case 130 is varied by the coupling case 150, the elastically deformable case seal 170 may cover the gap between the first case 120 and the second case 130, thereby more effectively preventing leakage through the gap.

However, embodiments of the present disclosure are not limited thereto, and in various embodiments, the case seal 170 may also contact the first case 120 and the second case 130 in the first direction (Z-direction).

According to an embodiment, the case seal 170 may have a substantially ring shape. The case seal 170 may have a ring shape with a central axis extending in the first direction (Z-direction).

Hereinafter, the process of assembling the case 110 will be described in detail with reference to FIGS. 17 and 18 by way of example.

Referring to FIG. 17, with the first case 120 and the second case 130 being separated, the deionization electrode 200 may have a first thickness T0 in the first direction (Z-direction). In an example, the first thickness T0 may be greater than the distance in the first direction (Z-direction) between the first horizontal cover portion 121 and the second horizontal cover portion 131 when the first case 120 and the second case 130 are maximally coupled (e.g., when the first thread 122a and the second thread 151a are maximally engaged).

The deionization electrode 200, by including, for example, a plurality of electrode layers stacked in the first direction (Z-direction), may be compressible in the first direction (Z-direction) and configured such that its thickness in the first direction (Z-direction) is variable. As shown in FIG. 18, as the second thread 151a of the coupling case 150 engages with the first thread 122a of the first case 120, the coupling case 150 may couple the second case 130 to the first case 120 and press the second case 130 in the first direction (Z-direction), and the second case 130 may move in the first direction (e.g., upward (+Z direction)) toward the first case 120. As the second case 130 moves toward the first case 120, the deionization electrode 200 may be depressed between the first case 120 and the second case 130. At this time, the deionization electrode 200 may be compressed to have a second thickness T1 smaller than the first thickness T0. The second thickness T1 of the deionization electrode 200 may be adjusted to be approximately equal to the distance between the first horizontal cover portion 121 and the second horizontal cover portion 131, thereby allowing the deionization electrode 200 to reliably contact the first terminal 310 penetrating the first horizontal cover portion 121 and the second terminal 320 penetrating the second horizontal cover portion 131, respectively.

According to an embodiment, the terminal (e.g., the first terminal 310 or the second terminal 320) may be movable relative to the case 110 (e.g., the first case 120 or the second case 130).

For example, the first terminal 310 may be movable relative to the first horizontal cover portion 121. The first horizontal cover portion 121 may include the first terminal coupling portion 121b provided for the first terminal 310 to be coupled thereto, and the first terminal 310 may penetrate the first terminal coupling portion 121b and be movable relative to the first terminal coupling portion 121b (see FIG. 19). The first terminal seal 350 may be disposed between the first terminal 310 and the first terminal coupling portion 121b (see FIG. 19). The first terminal seal 350 may surround the outer surface of the first terminal 310 (e.g., a body 310a of the first terminal 310, see FIG. 19). The first terminal seal 350 may apply an elastic force to the first terminal 310 (e.g., a head 310b of the first terminal 310, see FIG. 19) in a direction protruding inwardly of the case 110 from the first terminal coupling portion 121b (e.g., downward (−Z direction)). The first terminal seal 350 may press the first terminal 310 (e.g., the head 310b of the first terminal 310) toward the accommodating space of the case 110. When the first case 120 and the second case 130 are separated, at least a portion of the first terminal 310 (e.g., the head 310b) may protrude into the accommodating space of the case 110.

For example, the second terminal 320 may be movable relative to the second horizontal cover portion 131. The second horizontal cover portion 131 may include the second terminal coupling portion 131b provided for the second terminal 320 to be coupled thereto, and the second terminal 320 may penetrate the second terminal coupling portion 131b and be movable relative to the second terminal coupling portion 131b (see FIGS. 17 and 18). The second terminal seal 360 may be disposed between the second terminal 320 and the second terminal coupling portion 131b (see FIGS. 17 and 18). The second terminal seal 360 may surround the outer surface of the second terminal 320 (e.g., a body 320a of the second terminal 320, see FIG. 19). The second terminal seal 360 may apply an elastic force to the second terminal 320 (e.g., a head 320b of the second terminal 320) in a direction protruding inwardly of the case 110 from the second terminal coupling portion 131b (e.g., upward (+Z direction)). The second terminal seal 360 may press the second terminal 320 (e.g., the head 320b of the second terminal 320) toward the accommodating space of the case 110. When the first case 120 and the second case 130 are separated, at least a portion of the second terminal 320 (e.g., the head 320b) may protrude into the accommodating space of the case 110.

For example, referring to FIG. 17, when the second case 130 is separated from the first case 120, the second terminal 320 may protrude from the second terminal coupling portion 131b toward the interior of the case 110 in the first direction (Z-direction) (e.g., upward (+Z direction)) by a first length L0. The second terminal 320 may protrude from the second terminal coupling portion 131b by the first length L0 such that the head 320b is supported by the second terminal seal. Referring to FIG. 18, when the first case 120 and the second case 130 are coupled by the coupling case 150, the second terminal 320 may contact the deionization electrode 200. As the degree of coupling between the first case 120 and the second case 130 increases, the second terminal 320 may be pressed by the deionization electrode 200, and as the second terminal seal 360 is compressed, the protruding length of the second terminal 320 from the second terminal coupling portion 131b may decrease to be less than the first length L0. As such, even if the protruding length of the second terminal 320 decreases, the second terminal 320 may reliably maintain contact with the deionization electrode 200.

FIG. 19 is an enlarged cross-sectional view illustrating some configurations, such as a first terminal and a first deionization electrode, included in the water treatment device of the dishwasher according to an embodiment of the present disclosure. FIG. 20 is an enlarged cross-sectional view illustrating some configurations, such as a second terminal and a second deionization electrode, included in the water treatment device of the dishwasher according to an embodiment of the present disclosure.

Referring to FIGS. 19 and 20, a terminal included in the water treatment device 100 of the dishwasher 1 according to an embodiment of the present disclosure may protrude in an inward direction where the deionization electrode 200 is located relative to the case 110.

Referring to FIG. 19, the first terminal 310 may protrude in an inward direction (e.g., downward (−Z direction)) where the deionization electrode 200 is located relative to the first case 120. As described above, the first terminal 310 may penetrate the first terminal coupling portion 121b and may protrude in the inward direction (e.g., downward (−Z direction)) from the first terminal coupling portion 121b. For example, the first terminal 310 may protrude in the inward direction (e.g., downward (−Z direction)) from the first terminal coupling portion 121b by a second length L1.

In an example, the second length L1 may be greater than or equal to a thickness of the flow path partition 160.

The first terminal 310 may include the body 310a that penetrates the first terminal coupling portion 121b and the head 310b configured to contact the deionization electrode 200. The head 310b may have a larger horizontal width than the body 310a. The first terminal seal 350 may be disposed between the body 310a of the first terminal 310 and the inner surface of the first terminal coupling portion 121b. The first terminal seal 350 may press the head 310b of the first terminal 310 in an inward direction of the case 110 (e.g., downward (−Z direction)).

Thereby, the first terminal 310 may be more reliably connected to the deionization electrode 200.

The body 310a of the first terminal 310 and the inner surface of the first terminal coupling portion 121b may each be contacted in a direction different from the first direction (Z-direction) (e.g., the horizontal direction). Thus, even when the degree to which the first terminal seal 350 is compressed in the first direction (Z-direction) varies as the first terminal 310 moves in the first direction (Z-direction) relative to the first terminal coupling portion 121b, the gap between the body 310a of the first terminal 310 and the inner surface of the first terminal coupling portion 121b may be efficiently covered, and leakage from the case 110 may be efficiently prevented.

Referring to FIG. 20, the second terminal 320 may protrude in an inward direction (e.g., upward (+Z direction)) where the deionization electrode 200 is located relative to the second case 130. As described above, the second terminal 320 may penetrate the second terminal coupling portion 131b and may protrude from the second terminal coupling portion 131b in the inward direction (e.g., upward (+Z direction)). For example, the second terminal 320 may protrude in the inward direction (e.g., upward (+Z direction)) from the second terminal coupling portion 131b by a third length L2.

The second terminal 320 may include the body 320a that penetrates the second terminal coupling portion 131b and the head 320b configured to contact the deionization electrode 200. The head 320b may have a larger horizontal width than the body 320a. The second terminal seal 360 may be disposed between the body 320a of the second terminal 320 and the inner surface of the second terminal coupling portion 131b. The second terminal seal 360 may press the head 320b of the second terminal 320 in the inward direction of the case 110 (e.g., upward (+Z direction)).

Thereby, the second terminal 320 may be more reliably connected to the deionization electrode 200.

The body 320a of the second terminal 320 and the inner surface of the second terminal coupling portion 131b may each be contacted in a direction different from the first direction (Z-direction) (e.g., the horizontal direction). Thus, even when the degree to which the second terminal seal 360 is compressed in the first direction (Z-direction) varies as the second terminal 320 moves in the first direction (Z-direction) relative to the second terminal coupling portion 131b, the gap between the body 320a of the second terminal 320 and the inner surface of the second terminal coupling portion 131b may be efficiently covered, and leakage from the case 110 may be efficiently prevented.

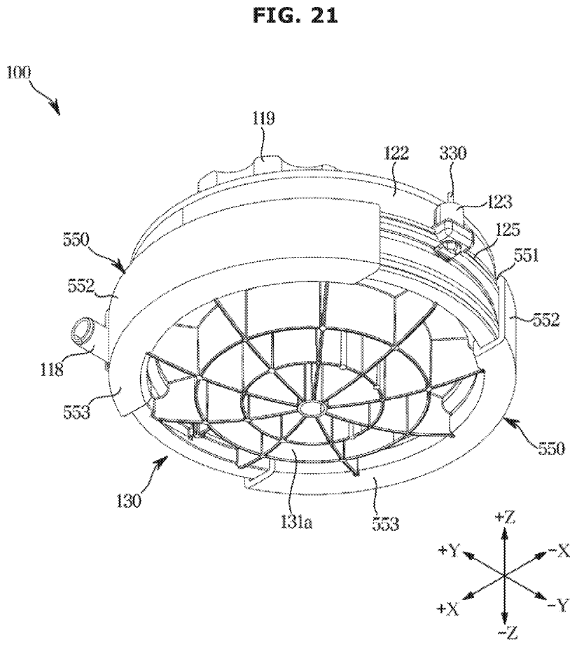

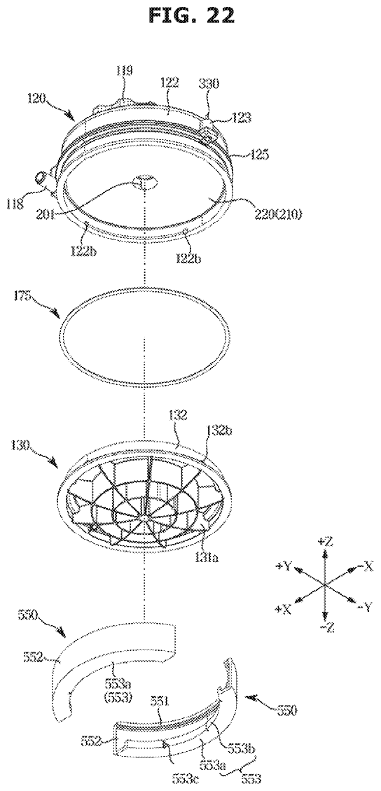

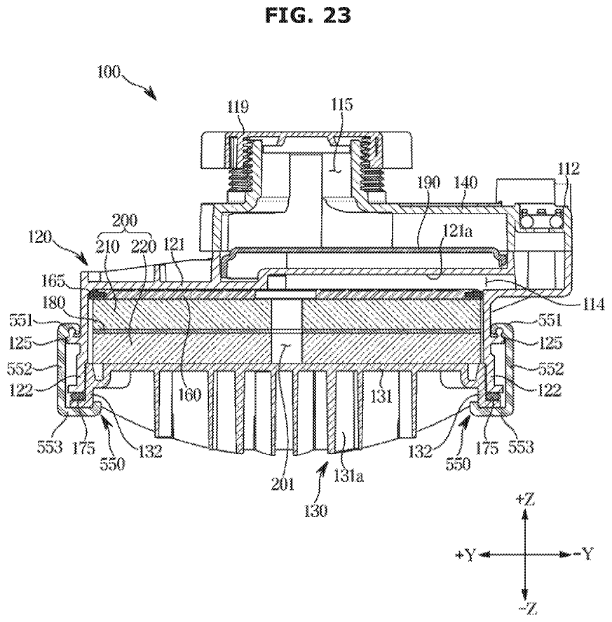

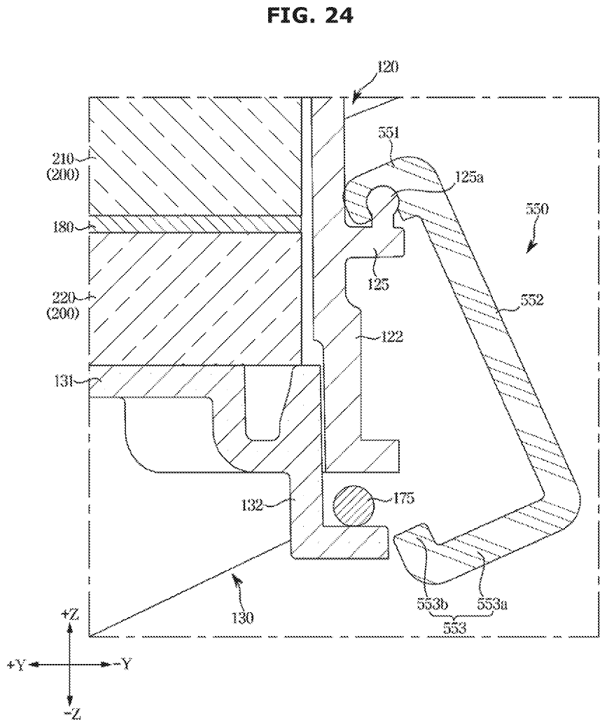

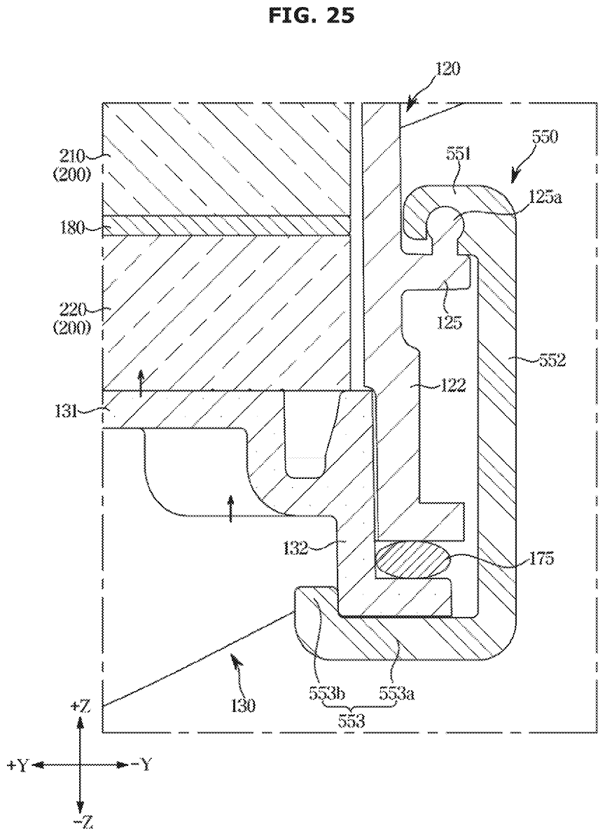

FIG. 21 is a perspective view illustrating a water treatment device of the dishwasher according to an embodiment of the present disclosure. FIG. 22 is an exploded perspective view illustrating some configurations of the water treatment device of the dishwasher according to an embodiment of the present disclosure. FIG. 23 is a cross-sectional view of the water treatment device of the dishwasher according to an embodiment of the present disclosure. FIG. 24 is an enlarged cross-sectional view illustrating a part of the water treatment device of the dishwasher according to an embodiment of the present disclosure, showing a state in which a first case and a second case are separated. FIG. 25 is an enlarged cross-sectional view illustrating a part of the water treatment device of the dishwasher according to an embodiment of the present disclosure, showing a state in which the first case and the second case are coupled.

In describing an embodiment of the present disclosure with reference to FIGS. 21 to 25, the same reference numerals may be assigned to configurations corresponding to those of the embodiment described with reference to FIGS. 1 to 20, and corresponding descriptions may not be repeated.

Referring to FIGS. 21 to 25, the water treatment device 100 of the dishwasher 1 according to an embodiment of the present disclosure may include the first case 120, the second case 130, and a coupling case 550.

The first case 120 of the embodiment according to FIGS. 21 to 25 may have a configuration corresponding to the first case 120 of the embodiment according to FIGS. 1 to 20 described above, and will not be described in detail. However, in the present embodiment, a thread (e.g., the first thread 122a) for coupling with the coupling case 550 may not be formed on the first case 120.

The second case 130 of the embodiment according to FIGS. 21 to 25 may have a configuration corresponding to the second case 130 of the embodiment according to FIGS. 1 to 20 described above, and will not be described in detail.

According to an embodiment, the coupling case 550 may be configured to couple the first case 120 and the second case 130. The coupling case 550 may support the second case 130 such that the second case 130 is held in a certain position relative to the first case 120.

According to an embodiment, the case 110 may include a plurality of coupling cases 550. In an example, the plurality of coupling cases 550 may be spaced apart from each other. In an example, the plurality of coupling cases 550 may be configured to couple the first case 120 and the second case 130 from opposite sides of each other.

According to an embodiment, the coupling case 550 may be configured to press the second case 130 toward the first case 120 when coupling the first case 120 and the second case 130. For example, the coupling case 550 may be configured to press the second case 130 in the first direction (Z-direction) (e.g., upward (+Z direction)) when coupling the first case 120 and the second case 130. When the second case 130 is pressed toward the first case 120, the deionization electrode 200 may be depressed and compressed between the first case 120 and the second case 130.

According to an embodiment, the coupling case 550 may be coupled to the first case 120. The coupling case 550 may include a case coupling portion 551 coupled to the first case 120. The first case 120 may include a coupling case support portion 125 provided for the case coupling portion 551 to be coupled thereto. In an example, the coupling case support portion 125 may be provided on the circumferential cover portion 122 of the first case 120. In an example, the coupling case support portion 125 may protrude from the outer surface of the circumferential cover portion 122.

According to an embodiment, the coupling case 550 may be rotatably coupled to the first case 120. The case coupling portion 551 may be rotatably coupled to the coupling case support portion 125. In an example, the case coupling portion 551 may be rotatably coupled to the coupling case support portion 125 on one side opposite to a hook 553, which will be described later. In an example, the coupling case support portion 125 may include a shaft 125a, and the case coupling portion 551 may be rotatably coupled to the shaft 125a. The coupling case 550 may be rotatable relative to the first case 120 about a rotation axis passing through the shaft 125a.

Alternatively, in various embodiments, a shaft may be provided on the case coupling portion 551 of the coupling case 550.

According to an embodiment, the coupling case 550 may cover the circumference of the first case 110 and/or the second case 120. The coupling case 550 may cover a case cover portion 552, and the case cover portion 552 may cover the circumferential cover portion 122 of the first case 110 and/or the circumferential wall 132 of the second case 120. In an example, the case cover portion 552 may extend from the case coupling portion 551. The case cover portion 552 may connect the case coupling portion 551 and the hook 553, which will be described later.

According to an embodiment, the coupling case 550 may include the hook 553. The hook 553 may be configured to be coupled to the second case 130. In an example, the hook 553 may be coupled to the second case 130 on a side opposite to the first case 120. In an example, the hook 553 may be coupled to the second case 130 on a side opposite to the deionization electrode 200. In an example, the hook 553 may be coupled to the second case 130 on a side opposite to the case coupling portion 551. The hook 553 may be configured to press the second case 130 toward the first case 120 when coupled to the second case 130. The hook 553 may extend from the case coupling portion 551.

The hook 553 may include a support 553a configured to support the second case 130. For example, the support 553a may be configured to support the second case 130 on a side opposite to the deionization electrode 200. For example, the support 553a may be configured to support the second case 130 on a side opposite to the first case 120. For example, the support 553a may be configured to support the second case 130 in the first direction (Z-direction). The support 553a may contact one side of the second case 130. For example, the support 553a may contact the lower side of the second case 130. For example, the support 553a may contact the lower end of the circumferential wall 132.

The support 553a may extend from the case coupling portion 551. For example, the support 553a may extend in a direction different from an extending direction of the case coupling portion 551. For example, the support 553a may extend inwardly from the case coupling portion 551. For example, the support 553a may extend inwardly from a lower end of the case coupling portion 551 to contact the second case 130.

When the coupling case 550 couples the first case 120 and the second case 130, the support 553a may press the second case 130 in the first direction (Z-direction) toward the first case 120.

The hook 553 may include a fixing rib 553b. The fixing rib 553b may be configured to be caught by the second case 130, thereby restricting the hook 553 from being easily deviating from the second case 130. For example, the fixing rib 553b may be configured to support the circumferential wall 132 of the second case 130 on a side opposite to the circumferential cover portion 122. For example, the fixing rib 553b may be configured to support the second case 130 in a direction different from the first direction (Z-direction) (e.g., the horizontal direction). For example, the fixing rib 553b may contact an inner surface of the second case 130 (e.g., an inner surface of the circumferential wall 132).

The hook 553 may be provided with a rib insertion portion 553c. A rib 131a of the second case 130 may be inserted into the rib insertion portion 553c. In an example, the rib insertion portion 553c may have a shape in which a portion of the hook 553 is cut in the first direction (Z-direction). This may prevent the hook from being interfered with by the rib 131a when the hook 553 is coupled to the second case 130.

According to an embodiment, the hook 553 may be configured to be elastically deformable. The hook 553 may include a variety of elastic materials, such as rubber, resin injection-molded product, metal, and the like.

With such a structure, the coupling case 550 may efficiently couple the first case 120 and the second case 130, and may press the second case 130 toward the first case 120 to ensure reliable contact between the terminals (e.g., the first terminal 310 or the second terminal 320) and the deionization electrode 200. In addition, the steps of assembling the case 110 or disassembling the case 110 may be simplified, and the manufacturing cost of the case 110 may be reduced. Furthermore, compared to examples in which the case 110 is assembled through processes such as separate screwing or thermal fusion, the embodiment of the present disclosure using the coupling case 150 may result in a better aesthetic quality of the water treatment device 100.

According to an embodiment, the water treatment device 100 may include a case seal 175 disposed between the first case 120 and the second case 130. The case seal 175 may be configured to cover the gap between the first case 120 and the second case 130 to prevent washing water inside the case 110 from leaking out.

While FIGS. 21 to 25 illustrate an embodiment in which the case seal 175 contacts the first case 120 and the second case 130 in the same direction (e.g., the first direction (Z-direction)) as the direction in which the second case 130 is movable relative to the first case 120, the present disclosure is not limited thereto. In various embodiments, the case seal 175 may contact the first case 120 and the second case 130 in a direction different from the direction in which the second case 130 is movable relative to the first case 120 (e.g., the first direction (Z-direction)).

While an embodiment in which the coupling case 550 is rotatably coupled to the first case 120 and coupled to the second case 130 via the hook 553 has been described above with reference to FIGS. 21 to 25, embodiments of the present disclosure are not limited thereto. In various embodiments, the coupling case 550 may be rotatably coupled to the second case 130 and may be coupled to the first case 120 via a hook. In various embodiments, the coupling case 550 may include a plurality of hooks and may be configured to be detachably coupled to each of the first case 120 and the second case 130.

According to an embodiment of the present disclosure, a water treatment device may include a case with an inlet port and an outlet port and a deionization electrode accommodated in the case and configured to adsorb ionic substances from water entering the case through the inlet port. The case may include a first case, a second case configured to be coupled to the first case such that an accommodating space in which the deionization electrode is arrangeable is formed between the first case and the second case based on a coupling of the first case with the second case, and a coupling case configured to couple the second case to the first case, the coupling case including a support configured to support the second case while the second case moves toward the first case to the first case.

The first case may include a first thread. The coupling case may include a second thread configured to be engaged with the first thread. The first case and the coupling case may be configured to be coupled by engaging the first thread with the second thread.

The first case may include a circumferential cover portion covering a circumferential surface of the deionization electrode. The first thread may be formed on an outer surface of the circumferential cover portion.

The coupling case may include a case coupling portion configured to cover the circumferential cover portion. The second thread may be formed on an inner surface of the case coupling portion.

The second case may be configured to contact at least a portion of an inner surface of the circumferential cover portion.

The support may support one side of the second case that is opposite the deionization electrode.

The support may extend from a portion of the coupling case that covers the first case.

The second case may be movable in one direction relative to the first case based on the coupling of the second case with the first case. The second case may be engaged with the first case to prevent movement of the second case in a direction different from the one direction relative to the first case.

The second case may be engaged with the first case to prevent the second case from rotating about a rotation axis extending in the one direction relative to the first case.

The first case may include a case groove recessed from an inner surface of the first case configured to cover at least a portion of the second case. The second case may include a case protrusion protruding from an outer surface of the second case and the case protrusion is configured to be received by the case groove.

The case groove may include a plurality of case grooves arranged along a circumferential direction of the inner surface of the first case. The case protrusion may include a plurality of case protrusions arranged along a circumferential direction of the outer surface of the second case such that each of the plurality of case grooves engage with a corresponding each of the plurality of case protrusions.

The water treatment device may further include a terminal electrically connected to the deionization electrode. The terminal may be configured to contact the deionization electrode in a direction in which the second case is movable relative to the first case based on the coupling of the second case with the first case.

The case may further include a terminal coupling portion coupled to the terminal. The terminal may include a body penetrating the terminal coupling portion and a head configured to contact the deionization electrode. The water treatment device may further include a terminal seal disposed between the body and the terminal coupling portion such that the terminal seal presses the head toward the accommodating space.

The case may include a terminal coupling portion coupled to the terminal. When the first case is separate from the second case, at least a portion of the terminal may protrude the accommodating space.

The water treatment device may further include a case seal between the first case and the second case.

According to an embodiment of the present disclosure, a dishwasher may include a tub, a spraying device configured to spray washing water into an interior of the tub, a sump configured to receive washing water to be supplied to the spraying device, and a water treatment device configured to treat washing water to be supplied to the sump. The water treatment device may include a deionization electrode, a terminal in contact with the deionization electrode and electrically connected to an external power source, a first case, a second case configured to be coupled to the first case such that an accommodating space in which the deionization electrode is arrangeable is formed between the first case and the second case based on a coupling of the first case with the second case, and a coupling case configured to couple the first case with the second case. The first case and the coupling case may each include a thread configured to engage with each other for coupling the first case and the coupling case.

The coupling case may be rotatable relative to the first case about a rotation axis extending in a direction in which the terminal contacts the deionization electrode. The degree of engagement between the thread of the first case and the thread of the coupling case may be adjustable as the coupling case is rotated relative to the first case.

As the degree of engagement between the thread of the first case and the thread of the coupling case increases, the second case may be configured to be pressed toward the first case by the coupling case.

According to an embodiment of the present disclosure, a water treatment device may include a deionization electrode, a terminal in contact with the deionization electrode and electrically connected to an external power source, a first case, a second case configured to be coupled to the first case such that an accommodating space in which the deionization electrode is arrangeable is formed between the first case and the second case based on a coupling of the first case with the second case, and a coupling case configured to couple the first case with the second case. The coupling case may include a hook configured to be coupled to the second case. The hook may be configured to press the second case toward the first case when coupled to the second case.

The coupling case may be rotatably coupled to the first case on one side that is opposite the hook.

According to the concept of the present disclosure, the water treatment device of the dishwasher may include the deionization electrode, adsorb ionic substances from raw water passing through the deionization electrode, and efficiently soften the raw water.

According to the concept of the present disclosure, the water treatment device of the dishwasher may be configured to adjust the degree to which the deionization electrode is pressed by adjusting the degree of coupling between the first case and the second case using the coupling case.

According to the concept of the present disclosure, the water treatment device of the dishwasher may reliably connect the terminal to the deionization electrode even when tolerances between components occur by adjusting the degree of coupling between the first case and the second case using the coupling case.

According to the concept of the present disclosure, the first case and the second case may be firmly assembled by the coupling case.

According to the concept of the present disclosure, the first case and the second case may be easily assembled by the coupling case even though a process such as separate screwing or welding is omitted, thereby simplifying the process of assembly and/or disassembly the case and reducing manufacturing costs.

According to the concept of the present disclosure, when the first case and the second case are coupled by the coupling case, the second case may be coupled to the first case such that the deionization electrode does not move in a direction different from the direction in which the deionization electrode contacts the terminal, thereby reducing and/or preventing the deionization electrode from being damaged due to friction with the terminal.

According to the concept of the present disclosure, the case seal may be provided between the first case and the second case, so that leakage from the case may be reduced and/or prevented.

According to the concept of the present disclosure, the direction in which the case seal contacts the first case and the second case and the direction in which the first case is movable relative to the second case may be different from each other, so that the case seal may more efficiently reduce and/or prevent leakage from the case.

The effects to be obtained from the present disclosure are not limited to the effects mentioned above, and other unmentioned effects can be clearly understood by those of ordinary skill in the art to which the present disclosure pertains from the description below.

While the present disclosure has been particularly described with reference to exemplary embodiments, it should be understood by those of skilled in the art that various changes in form and details may be made without departing from the spirit and scope of the present disclosure.

1. A water treatment device, comprising:
a case with an inlet port and an outlet port; and
a deionization electrode accommodated in the case and configured to adsorb ionic substances from water entering the case through the inlet port,
wherein the case includes:
a first case,
a second case configured to be coupled to the first case such that an accommodating space in which the deionization electrode is arrangeable is formed between the first case and the second case while the second case and the first case coupled to each other, and
a coupling case configured to couple the second case to the first case, the coupling case including a support configured to support the second case while the second case moves toward the first case to couple to the first case.

2. The water treatment device of claim 1, wherein
the first case includes a first thread,
the coupling case includes a second thread configured to engage with the first thread, and
the first case and the coupling case are configured to be coupled by the first thread and the second thread engaging with each other.

3. The water treatment device of claim 2, wherein
the first case includes a circumferential cover portion configured to cover a circumferential surface of the deionization electrode, and
the first thread is formed on an outer surface of the circumferential cover portion.

4. The water treatment device of claim 3, wherein
the coupling case includes a case coupling portion configured to cover the circumferential cover portion, and
the second thread is formed on an inner surface of the case coupling portion.

5. The water treatment device of claim 3, wherein the second case is configured to contact at least a portion of an inner surface of the circumferential cover portion.

6. The water treatment device of claim 1, wherein the support is configured to support one side of the second case that is opposite the deionization electrode.

7. The water treatment device of claim 1, wherein the support extends from a portion of the coupling case that covers the first case.

8. The water treatment device of claim 1, wherein the second case is movable along one direction relative to the first case while the second case is coupled to the first case, and the second case is engaged with the first case such that the second case is prevented from moving along a direction different from the one direction relative to the first case.

9. The water treatment device of claim 8, wherein the second case is engaged with the first case such that the second case is prevented from rotating about a rotation axis extending in the one direction relative to the first case.

10. The water treatment device of claim 8, wherein
the first case includes a case groove recessed from an inner surface of the first case configured to cover at least a portion of the second case, and
the second case includes a case protrusion protruding from an outer surface of the second case, which is configured to be received by the case groove.

11. The water treatment device of claim 10, wherein
the case groove includes a plurality of case grooves arranged along a circumferential direction of the inner surface of the first case, and
the case protrusion includes a plurality of case protrusions arranged along a circumferential direction of the outer surface of the second case such that the plurality of case grooves correspondingly engage with the plurality of case protrusions.

12. The water treatment device of claim 1, further comprising a terminal to be electrically connected to the deionization electrode,
wherein the terminal is configured to contact the deionization electrode along a direction in which the second case is movable relative to the first case while the second case is coupled to the first case.

13. The water treatment device of claim 12, wherein the case further includes a terminal coupling portion coupleable to the terminal,
the terminal includes:
a body penetrating the terminal coupling portion, and
a head configured to contact the deionization electrode, and
the water treatment device further comprising a terminal seal between the body and the terminal coupling portion such that the terminal seal presses the head toward the accommodating space.

14. The water treatment device of claim 12, wherein
the case further includes a terminal coupling portion coupleable to the terminal, and
while the first case is separated from the second case, at least a portion of the terminal protrudes from the terminal coupling portion into the accommodating space.

15. The water treatment device of claim 1, further comprising:
a case seal between the first case and the second case.
